(19) United States
(12) Patent Application Publication
(10) Pub. No.: US 2014/0191527 A1
(43) Pub. Date: Jul. 10, 2014

(54) MODULAR LOAD SUPPORT AND ATTACHMENT APPARATUS AND SYSTEM FOR A VEHICLE

(71) Applicant: Rick Riley, Alhambra, IL (US)

(72) Inventor: Rick Riley, Alhambra, IL (US)

(21) Appl. No.: 14/054,203

(22) Filed: Oct. 15, 2013

Related U.S. Application Data
(63) Continuation-in-part of application No. 13/739,981, filed on Jan. 11, 2013.
(60) Provisional application No. 61/713,091, filed on Oct. 12, 2012.

(51) Int. Cl. B60R 9/00

(52) U.S. Cl. CPC B60R 9/00
USPC 296/3

(57) ABSTRACT

The apparatus and system for supporting and attaching loads on a vehicle, is adapted for installation on side walls of pick up truck beds, providing discrete attachment points for ratcheting straps and the like for securing the loads. The attachment points include attachment slots incorporated along rails on or incorporated with the tops of the walls. The rails can be integrated into a cap structure mounted on or integrated with the upper surface of the wall, or formed in the wall when manufactured, and the rails can extend along all or a part of the length of the wall. If mounted on the top of a wall, the rail can be permanently or removably integrated with the cap structure, and mounted in a variety of manners, including with fasteners or clamps, such as in existing stake holes.

This application claims priority to U.S. Provisional Application No. 61/713,091, filed Oct. 12, 2012, and is a continuation-in-part of co-pending U.S. patent application Ser. No. 13/739,981, filed Jan. 11, 2013 which is a non-provisional application claiming priority to U.S. Provisional Application No. 61/585,592, filed Jan. 11, 2012.

### TECHNICAL FIELD

The present invention relates generally to an apparatus and system for supporting and attaching of loads to a vehicle, and more particularly, which can be configured for permanent installation, or adapted for removable installation, on a variety of vehicles particularly on the side walls of pick up truck beds, and also work trucks, and vans, in a variety of configurations for adapting to different loads, and which provides a multitude of discrete attachment points for ratcheting straps and the like for securing the loads.

### BACKGROUND ART

U.S. patent application Ser. No. 13/739,981 filed Jan. 11, 2013; U.S. Provisional Application No. 61/713,091, filed Oct. 12, 2012, and U.S. Provisional Application No. 61/585,592, filed Jan. 11, 2012, are incorporated herein by reference in their entireties.

A broad variety of load attachment apparatus and systems for installation on vehicles such as pick up trucks, work trucks, vans, and the like, are well known. Reference for instance, known utility or ladder racks available from a variety of manufacturers, that include upstanding support members mountable in stake pockets or on bed walls of pickup trucks and which support cross members above the truck bed for carrying ladders, lumber, boats, and other loads. The known racks of this type are typically supplied in a set configuration, but can be adjusted for different width pickup truck beds, and height of the cross member. These racks can be categorized as typically providing few or no dedicated elements for attachment of tie down ropes or straps for securing the loads beyond the support members and cross members themselves. As a result, tie down elements such as ropes and the like usually must be just looped or wrapped about the support or cross members of the rack, a disadvantage of which is that they can have a tendency to slide or creep along the member to which they are attached, so as to possibly loosen, resulting in less securing of the load, particularly when used with mechanical advantage devices such as ratcheting mechanisms and the like. To avoid this, it is common to wrap the straps around the joints between the support and cross members, but this reduces the versatility of the racks.

Reference also known pick up truck racks available from TracRac, Inc., of Fall River, Mass. USA, which utilizes side rails that mount on the tops of the bed walls of a pick up truck. The side rails slidably receive and support upstanding front and rear racks including fixed cross members having longitudinal slots for attachment of brackets for supporting and securing ladders, canoes, kayaks, lumber and the like, to the cross members using proprietary fittings. For attachment of tie down straps and the like, the TracRac racks can include rings having mounting elements for slidable attachment to the side rails using proprietary fittings. However, it is unknown whether the ring mounts are sufficiently secure for use with mechanical advantage devices such as ratcheting straps. Some versions of the TracRac system includes cleats at limited locations on upstanding support members of the racks for attachment of ropes and cords for tie down purposes, but these appear to be too light duty for attachment of larger ratcheting straps and the like.

An additional shortcoming of the known rack systems of both types reference above is that the fixed cross members limit versatility for carrying different load items separately, for example, different sizes of lumber or the like.

What is sought therefore is apparatus for supporting and attaching loads to a vehicle that overcomes one or more of the shortcomings and limitations set forth above.

### SUMMARY OF THE INVENTION

What is disclosed is apparatus and a system for supporting and attaching loads to a vehicle that overcomes one or more of the shortcomings and limitations set forth above.

According to a preferred aspect of the invention, the present invention relates generally to an apparatus and system for supporting and attaching of loads to a vehicle, and more particularly, which can be permanently installed or removably installed on a variety of vehicles particularly on the side walls of pick up truck beds, and also work trucks, and vans, in a variety of configurations for adapting to different loads, and which provides a multitude of discrete attachment points for ratcheting straps and the like for securing the loads.

According to another preferred aspect of the invention, the discrete attachment points are embodied in arrays or patterns of attachment slots incorporated along rails mounted to or otherwise incorporated with the tops of walls of a pick up truck bed. In several embodiments, rails are integrated into an elongate cap structure that is mounted on or integrated with the upper surface of the wall. To facilitate this, the rail can be attached to or incorporated into an elongate top cap of sheet metal or plastics that covers or comprises the upper surface of the associated wall. As a non-limiting example, the rail can be welded to the top cap. As another non-limiting example, the rail can be fastened to the top cap. As other examples, the top cap can capture opposite longitudinally extending peripheral edges of the rail; such as by being molded thereabout, or include a slot for slidably receiving the rail. As still another example, the rail can be formed in or as the top of a wall when manufactured. If mounted on the top of a wall, the top cap can have a concave or similar shape bottom surface that preferably at least generally conforms to the shape of the upper surface of the wall, so as to be securely held thereon in a suitable manner, e.g., using fasteners, clamps, or the like.

As additional preferred aspects of the invention, an elongate C-shape channel extending along the top of a wall is configured for receiving rails including the discrete attachment slots, and is securable using simple elements such as set screws or the like, enabling the rails to be quickly and easily installed and also removed, which can be desirable for a variety of purposes, including for reconfiguring the system in different manners for carrying and/or securing different loads. In this regard, it is contemplated that the rails can be provided in different lengths, including that match the length of the C-shape channel or smaller lengths, for instance, 1 or 2 foot lengths. The C-shape channel can incorporate a top cap of sheet metal or plastics that covers or comprises the upper surface of the associated wall in the above described manner, and the top cap can have a suitably shaped bottom surface for securely mounting in mating relation to the top surface of a wall, as also described above.

As additional aspects of the invention, the top caps can be secured using fasteners, such as toggle bolts, incorporated into the side wall as an OEM item, clamped, e.g., using brackets or clamps such as expanding clamps, or using resiliently expandable plugs of rubber or rubbery material received in stake pockets or holes of the side wall, and expanded by tightening draw bolts or the like. The C-shape channels can also be attached to the front wall and/or rear wall or gate of a pick up truck, as desired for a particular application.

As additional, optional features, the C-shaped channels can be configured to slidably receive mounting ends of upstanding support members of rack components. These can also be secured in position in a simple manner, such as using set screws threadedly received in threaded holes at locations along the channel. The upstanding support members will typically be located at the front and rear ends of the side walls of a pick up truck bed, in the manner of conventional ladder racks and the like, but can be located at any point along the C-shape channels. In a representative combination configuration of the invention, upstanding support members will be located at the front and rear ends of the C-shape channels, and shorter rails including the attachment slots along the length thereof will be located in the C-shape channels between the upstanding support members, to provide a large number of attachment locations for straps and the like between the support members.

As still additional preferred aspects, the load securing capability of the invention can be incorporated into short rails including just one or a small number of the attachment slots. The rails can be securely attached or mounted on the upper surface of a wall in a variety of ways, including any of those described above, namely, using a fastener, such as a toggle bolt, draw bolt clamp, or an expanding clamp, or the like, in association with any of the stake pockets or holes of a wall, if desired.

According to the invention, the discrete attachment slots are configured for attachment of fittings or locking or latching mechanisms for securing items such as, but not limited to, ratcheting tie down straps, cross members, fittings, cargo rings, and the like, for supporting and securing loads.

### BRIEF DESCRIPTION OF THE DRAWINGS

FIG. 1 is a rear view of a pickup truck including one embodiment of a modular apparatus and system for support and attachment of loads to a vehicle, constructed and operable according to the teachings of the invention, and showing a rack structure of the invention configured in one manner supporting sporting equipment, namely, boats;

FIG. 2 is another rear view of the pickup truck including the apparatus and system for support and attachment of loads to a vehicle, showing the rack structure of the invention configured supporting boats in another manner;

FIG. 3 is another rear view of the pickup truck including an embodiment of the modular apparatus and system of the invention, and a load of construction materials;

FIG. 4 is another rear view of the pickup truck and apparatus and system of the invention, showing the load of construction materials segregated and carried on the system;

FIG. 5 is a perspective view showing elements of the apparatus and system of the invention;

FIG. 6 is another perspective view showing elements of the apparatus and system of the invention, and an associated ratcheting strap for securing a load;

FIG. 7 is another perspective view showing elements of the apparatus and system of the invention, and an associated strap for securing a load;

FIG. 8 is another perspective view showing elements of the apparatus and system of the invention, and a strap for securing a load;

FIG. 9 is another perspective view showing elements of the apparatus and system of the invention, and an associated ratcheting strap for securing a load;

FIG. 10 is a perspective view showing elements of the apparatus and system of the invention, showing aspects of an embodiment of a rack structure thereof;

FIG. 11 is another perspective view showing elements of the apparatus and system of the invention, showing aspects of the rack structure of FIG. 10;

FIG. 12 is another perspective view showing elements of the apparatus and system of the invention, showing aspects of a rack structure;

FIG. 13 is another perspective view showing elements of the apparatus and system of the invention, showing aspects of rails thereof;

FIG. 14 is another perspective view showing elements of the apparatus and system of the invention, showing aspects of the rails;

FIG. 15 is another perspective view showing elements of the apparatus and system of the invention, showing aspects of the rails;

FIG. 16 is another perspective view showing elements of the apparatus and system of the invention, showing aspects for supporting equipment on upstanding support elements of the rack system;

FIG. 17 is another perspective view showing aspects for supporting equipment on upstanding support elements of the rack structure;

FIG. 18 is another perspective view showing aspects for supporting equipment on upstanding support elements of the rack structure;

FIG. 19 is a perspective view showing aspects of one embodiment of a rail of the apparatus and system of the invention;

FIG. 20 is a perspective exploded view showing aspects of one embodiment of a rail of the apparatus and system of the invention;

FIG. 21 is another perspective exploded view showing aspects of one embodiment of a rail of the apparatus and system of the invention;

FIG. 22 is another perspective view showing aspects of one embodiment of a rail of the apparatus and system of the invention, showing sliding receipt of the rail in a channel;

FIG. 23 is a perspective view showing aspects of one embodiment of a rail of the apparatus and system of the invention, in association with upstanding support elements of a rack structure of the invention;

FIG. 24 is a perspective exploded view of one embodiment of a rail of the apparatus and system of the invention, in association with upstanding support elements of a rack structure of the invention

FIG. 25 is a side view showing aspects of one embodiment of upstanding support elements of a rack structure of the invention;

FIG. 26 is various views showing aspects of apparatus of the invention for attaching channels and/or rails to a wall;

FIG. 27 is various views showing aspects of additional apparatus of the invention for attaching channels and/or rails to a wall;

FIG. 28 is a perspective view showing one manner of securing of a rail in a channel on a wall of a truck;

FIG. 29 is various views showing apparatus of the invention for mounting channels and/or rails to a wall of a truck;

FIG. 30 is various views showing aspects of apparatus of the invention for attaching channels and/or rails to a wall;

FIG. 31 is various views showing aspects of apparatus of the invention for attaching channels and/or rails to a wall;

FIG. 32 is various views showing aspects of apparatus of the invention for attaching channels and/or rails to a wall;

FIG. 33 is various views showing aspects of apparatus of the invention for attaching channels and/or rails to a wall;

FIG. 34 is various views showing aspects of apparatus of the invention for attaching channels and/or rails to a wall;

FIG. 35 is an end view of another embodiment of the invention for incorporating a rail onto a wall;

FIG. 36 is a simplified perspective view of a representative pickup truck, showing an embodiment of vehicle load support and attachment apparatus of the invention incorporated on representative walls, which are side walls bounding a bed of the truck;

FIG. 36A is a simplified perspective view of a representative pickup truck, showing another embodiment of vehicle load support and attachment apparatus of the invention incorporated on side walls of the truck;

FIG. 37 is an end view of another embodiment of the invention for incorporating a rail on to a wall;

FIG. 38 is a simplified perspective view of a representative pickup truck, showing another embodiment of vehicle load support and attachment apparatus of the invention incorporated on a representative wall, which is a side wall bounding a bed of a pickup truck;

FIG. 39 is a perspective view showing aspects of another apparatus of the invention for attaching channels and/or rails to a wall;

FIG. 40 is a perspective view showing aspects of another apparatus of the invention for attaching channels and/or rails to a wall;

FIG. 41 is a perspective view showing aspects of another apparatus of the invention for attaching channels and/or rails to a wall;

FIG. 42 is a perspective view showing aspects of another apparatus of the invention for attaching channels and/or rails to a wall;

FIG. 42A is a perspective view showing aspects of the apparatus of FIG. 42;

FIG. 42B is another perspective view showing aspects of the apparatus of FIG. 42;

FIG. 42C is still another perspective view showing aspects of the apparatus of FIG. 42;

FIG. 43 is a perspective view showing aspects of another apparatus of the invention for attaching channels and/or rails to a wall;

FIG. 44 is a perspective view showing aspects of another apparatus of the invention for attaching channels and/or rails to a wall;

FIG. 45 is a perspective view showing aspects of another apparatus of the invention for attaching channels and/or rails to a wall;

FIG. 45A is a perspective view showing aspects of the apparatus of FIG. 45;

FIG. 45B is another perspective view showing aspects of the apparatus of FIG. 45; and

FIG. 45C is still another perspective view showing aspects of the apparatus of FIG. 45.

### DETAILED DESCRIPTION OF THE INVENTION

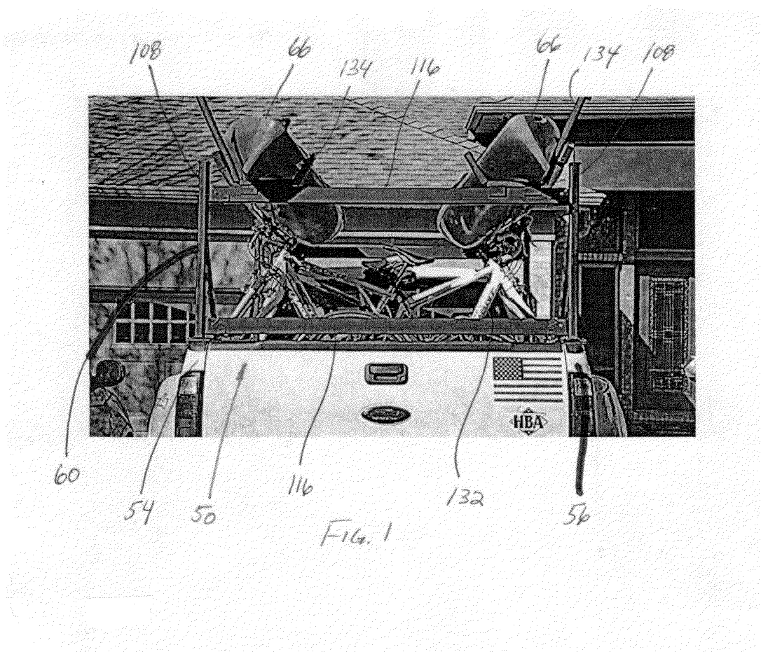

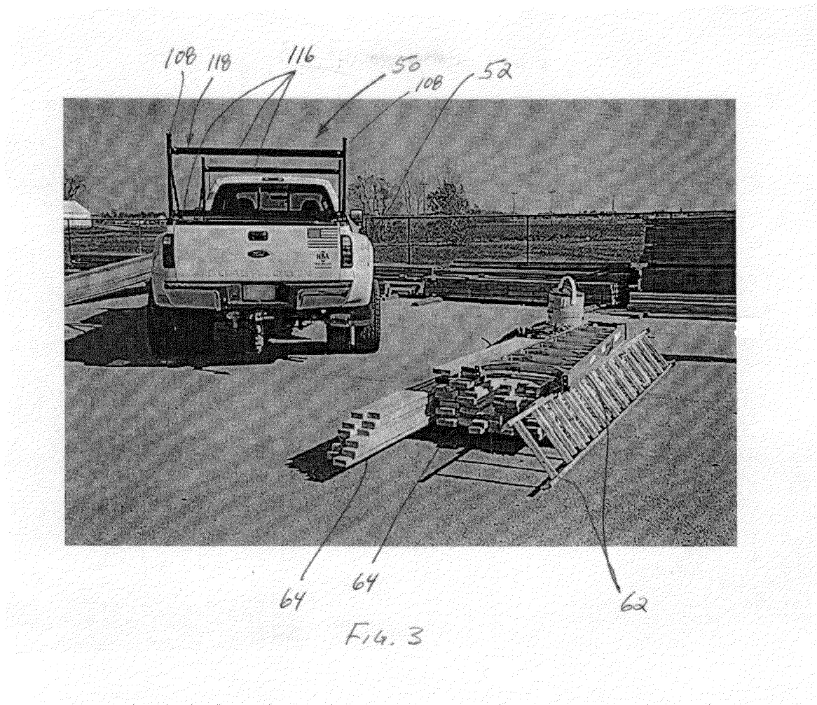

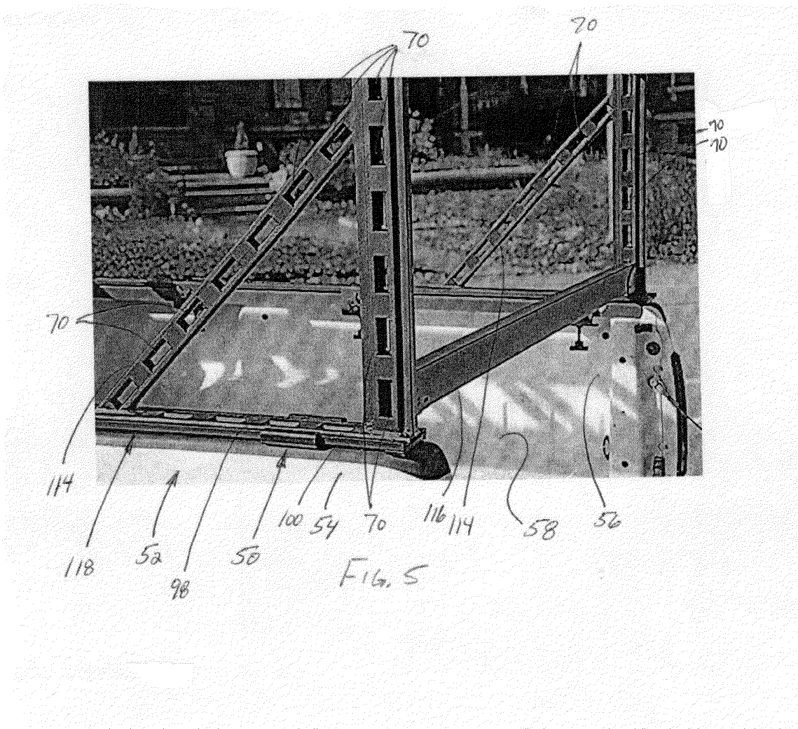

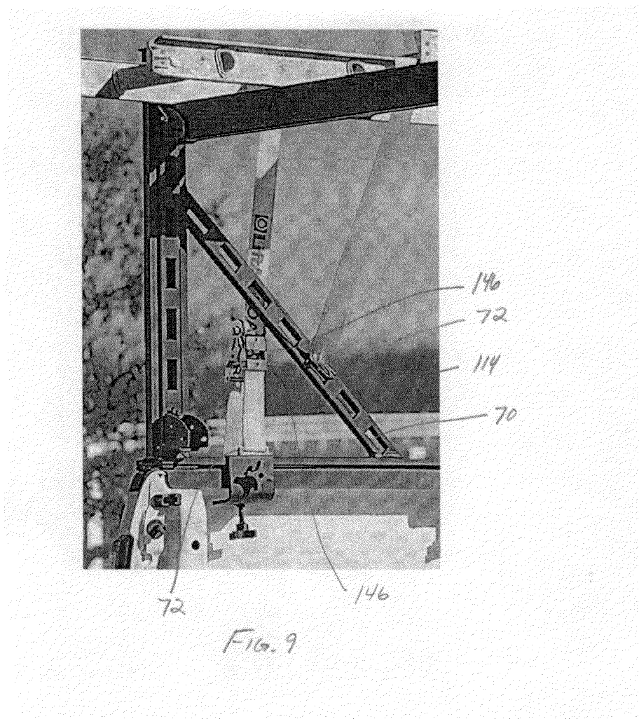

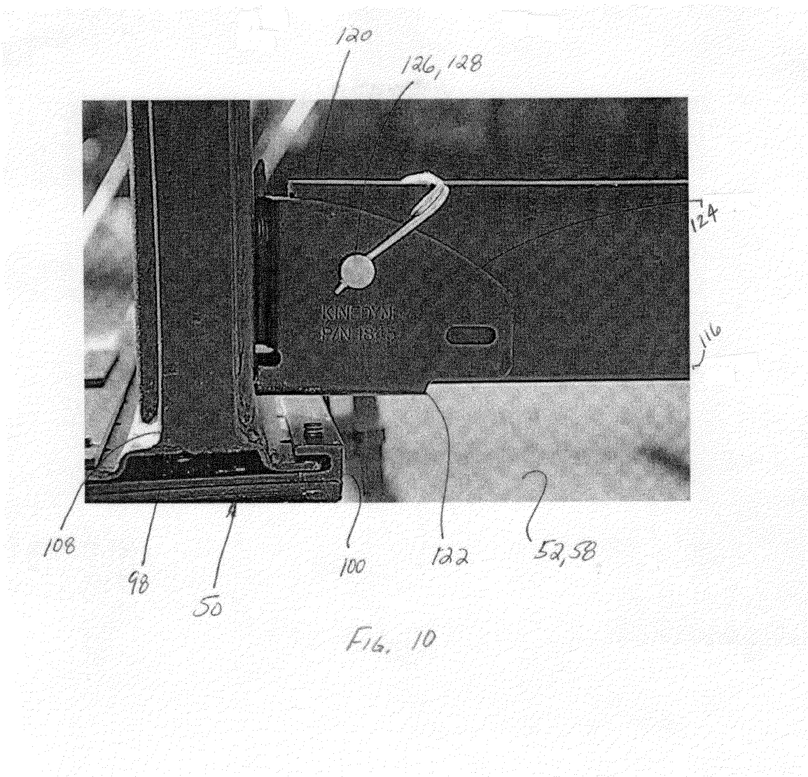

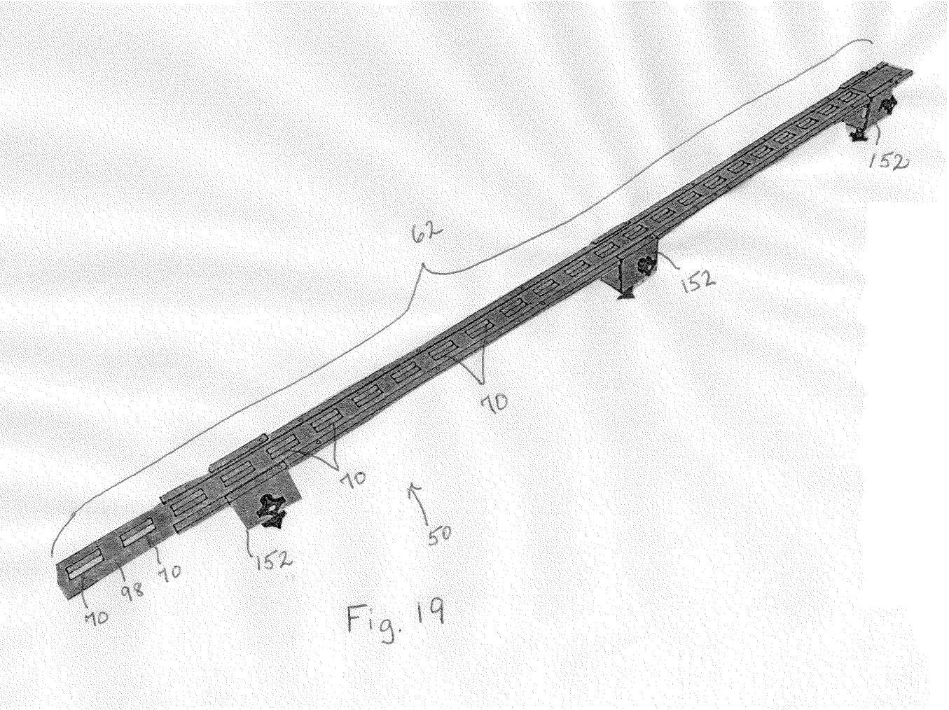

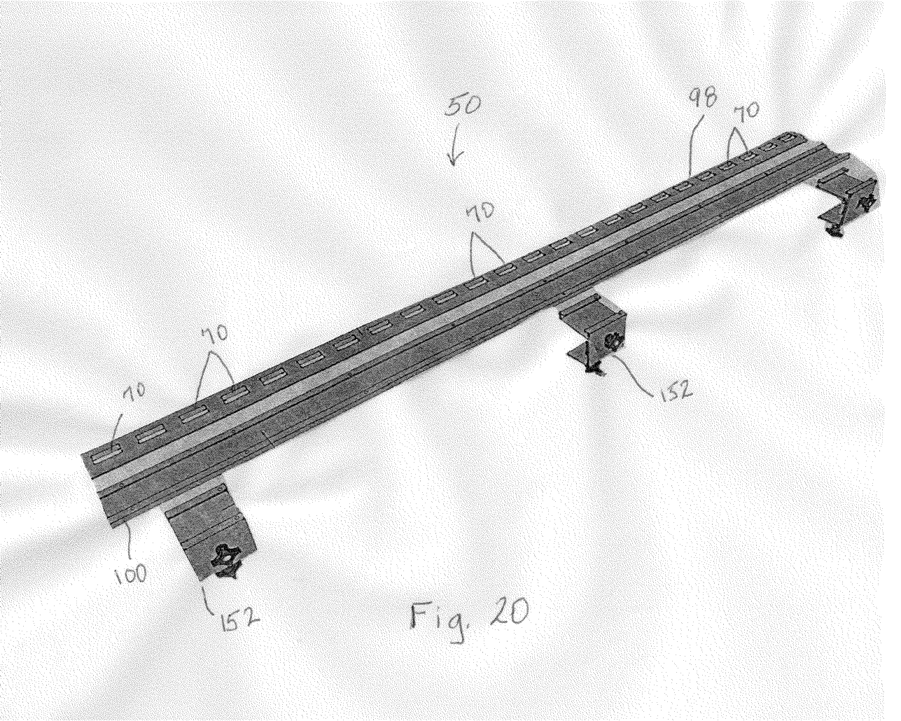

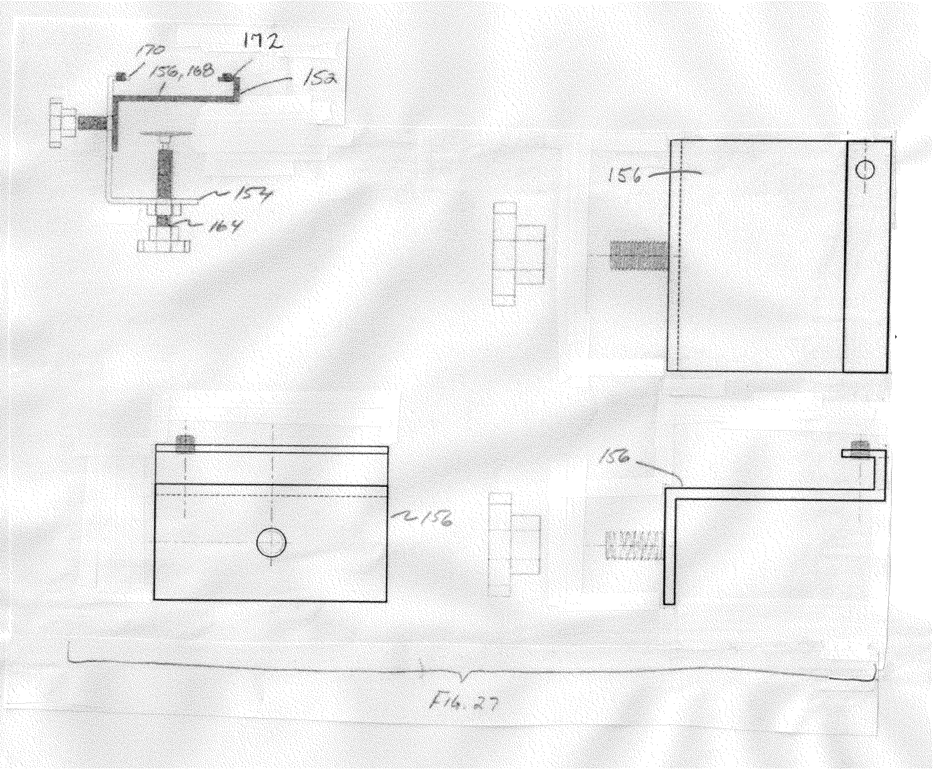

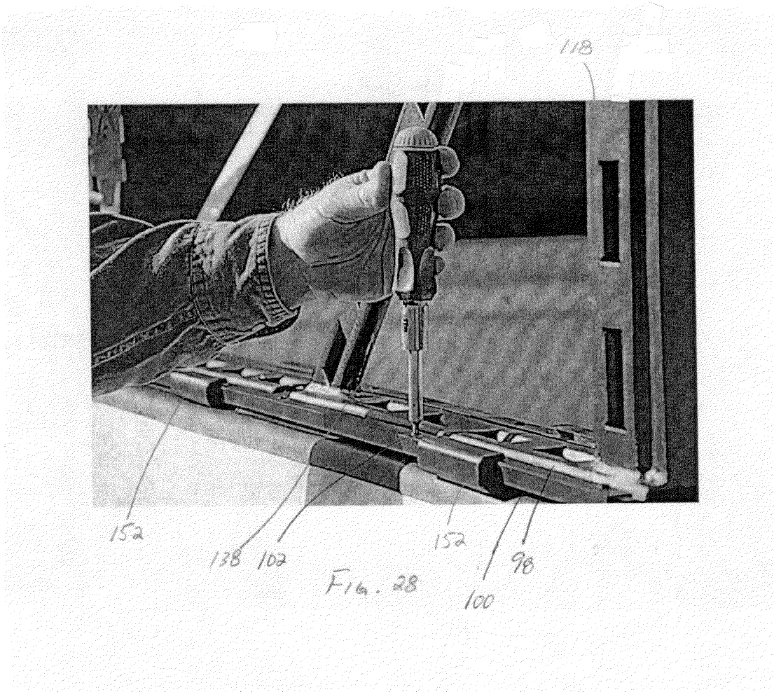

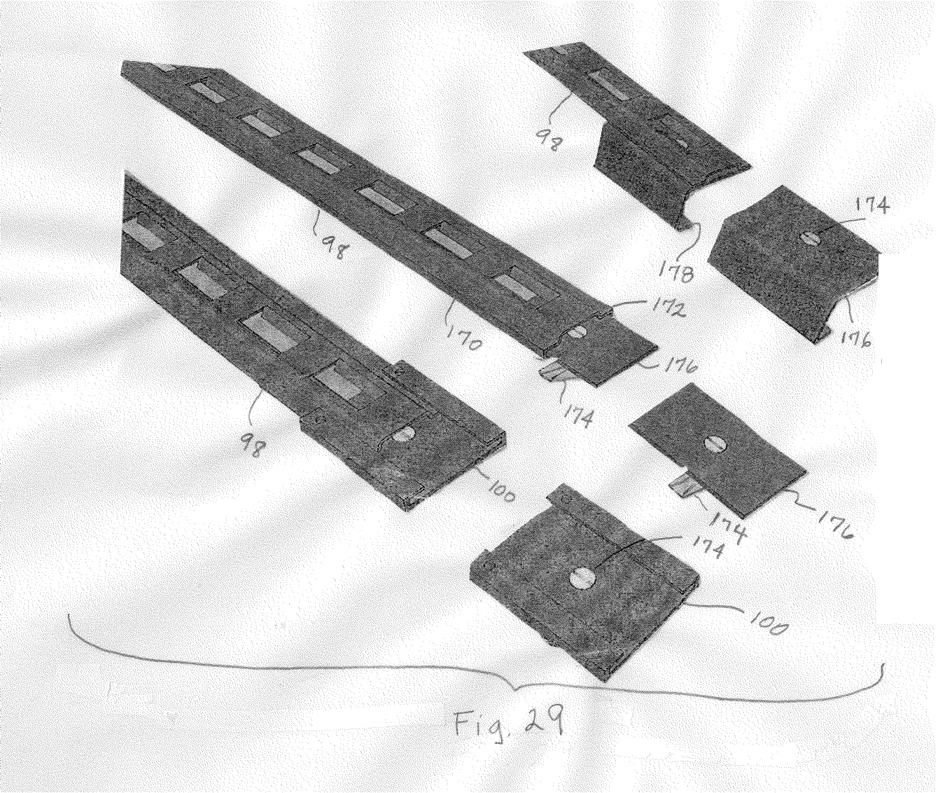

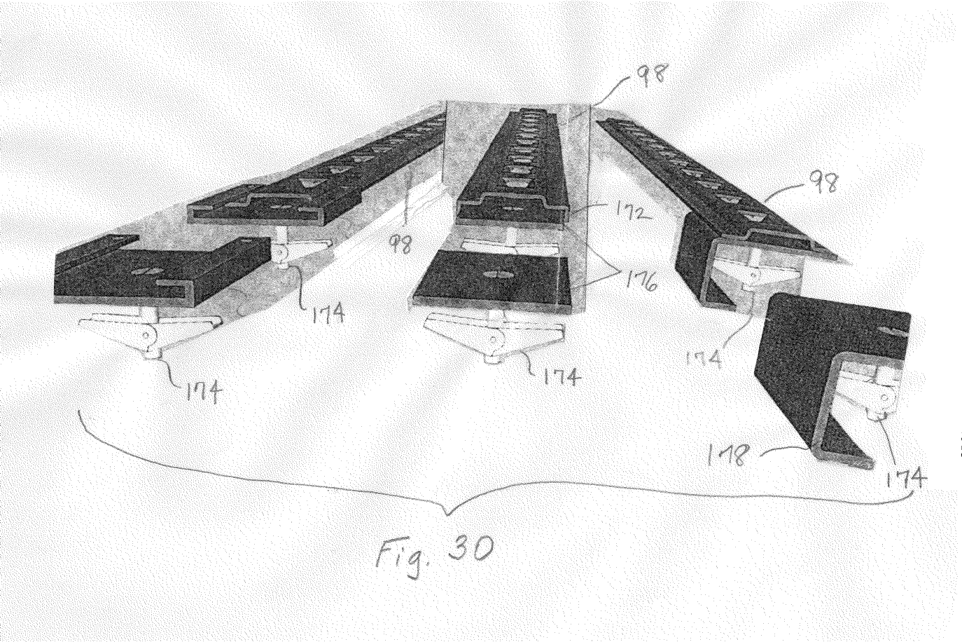

Referring now to FIGS. 1 through 34, what is disclosed is an apparatus and system 50 for support and attachment of loads to a vehicle 52, adapted for quick and easy installation on a variety of vehicles particularly on the side walls 54 and 56 of a pick up truck bed 58, and also work or cargo trucks and vans (not shown), in a variety of configurations for adapting to different loads, and which provides a multitude of discrete attachment points for securing the loads, particularly for ratcheting straps and the like.

The system 50 of the invention can be configured for just securing loads to the side walls 54 and 56 of a pick up truck bed 58, or providing an upstanding rack structure 60 for carrying loads such as ladders 62, lumber 64, boats 66, and the like. To facilitate this versatility, a central component of the apparatus and system 50 of the invention is an elongate array or pattern 68 of attachment slots 70 configured and operable for attachment of fittings or locking or latching mechanisms 72 for securing items such as ratcheting tie down straps 74, cross members 76, and the like.

The attachment slots 70 are of uniform configuration, having an elongate rectangular shape bounded on the opposite longitudinal ends by opposing edges 78 and 80, with lips 82 and 84 along the opposing edges of the slot 70 extending between the longitudinal ends for stiffening and strengthening the structure in which the slots 70 are located. The slots 70 can be configured in side by side or end to end relation, end to end being preferred and illustrated. Behind or beneath each attachment slot 70 is a space 86, configured to receive a locking bar 88 of a locking or latching mechanism 72 engageable with the longitudinally opposing edges 78 and 80 bounding the slot 70. Such attachment slots 70 and latching mechanisms 72 are preferably of well known construction, such as illustrated in Klekar U.S. Pat. No. 4,033,268, issued Jul. 5, 1977, the disclosure of which is incorporated herein in its entirely by reference, latching mechanisms 72 typically including a locking bar 88 having one fixed end 90 and an outwardly spring biased opposite end 92, wherein the spring biased end is manually retractable into the mechanism by moving a button or lever 94 to enable insertion of the locking bar 88 into a respective attachment slot 70 to engage shoulders 96 on the ends of the locking bar 88 with the opposite inner portions of edges 78 and 80 bounding the slot 70 when the retracted end of the locking bar 88 is released, for capturing the locking bar 88 in the slot for secure attachment of the mechanism 72 and item attached thereto, to the rail or other structural element on which the slot 70 is located. In this manner, the latching mechanism 72 is securely fixed or locked to the structure bounding the attachment slot 70, until manually released by retraction of the spring biased end of the locking bar 88. These attachment slots 70 are commonly provided on rails located along the walls and floors of commercial truck boxes and trailers and a wide variety of devices such as ratcheting tie down straps 74, cords, chains, and the like, include the illustrated latching mechanisms 72 used in the apparatus and system 50 of the invention. As an advantage, the ratcheting tie down straps 74 and other tie down devices are widely commercially available and a user is not limited to proprietary devices for securing loads.

In this invention, the arrays or patterns 68 of attachment slots 70 are incorporated along rails 98 configured to be mounted to the tops of side walls 54, 56 of a pick up truck bed 58. In a preferred configuration, the rails 98 are slidably receivable in an elongate C-shape channel 100 extending along the top of the side wall 54, 56, and securable using simple elements such as set screws 102 tightenable by hand using a driver 104 or the like (FIG. 28), enabling the rails 98 to be quickly and easily installed and also removed, which can be desirable for a variety of purposes, including for reconfiguring the system in different manners for carrying and/or securing different loads as will be explained and illustrated. In this regard, it is contemplated that the rails 98 can be provided in different lengths, including that match the length of the C-shape channel 100, or smaller lengths, for instance, 1 or 2 foot lengths as illustrated in some of the FIGS.

The C-shape channel 100 of the invention can be fixed to a side wall 54, 56 of a pick up truck, or to any other desired mounting base such as the floor or wall of a commercial truck or trailer (not shown), in any convenient, secure manner. In the instance of the pick up truck illustrated, which is representative of a wide variety of vehicles 52 with which the invention can be used, the C-shape channels 100 can be secured using brackets received in stake pockets of the side wall; using fasteners, such as toggle bolts 174 shown in FIG. 30; incorporated into the side wall as an OEM item; or clamped using clamps 152 as illustrated in various FIGS. The C-shape channels 100 can also be attached to the front wall and/or rear wall or gate of a pick up truck, as desired for a particular application. For commercial truck applications, it is contemplated that the channels would be attached in the conventional manner using fasteners such as screws or the like, nails, clamps, or welding.

The C-shaped channels 100 are configured to slidably receive mounting ends 106 of upstanding support members 108 of the rack components of the system. These will also be secured in position in a simple manner, such as using set screws 102 threadedly received in threaded holes at locations along the channel 100. The upstanding support members 108 will typically be located at the front and rear ends of the side walls 54, 56 of a pick up truck bed 58, in the manner of conventional ladder racks and the like, but can be located at any point along the C-shape channels 100. In a representative combination configuration of the invention, upstanding support members 108 will be located at the front and rear ends of the C-shape channels 100, and shorter rails 98 including the attachment slots 70 along the length thereof will be located in the C-shape channels 100 between the upstanding support members 108, to provide a large number of attachment locations for straps and the like between the support members.

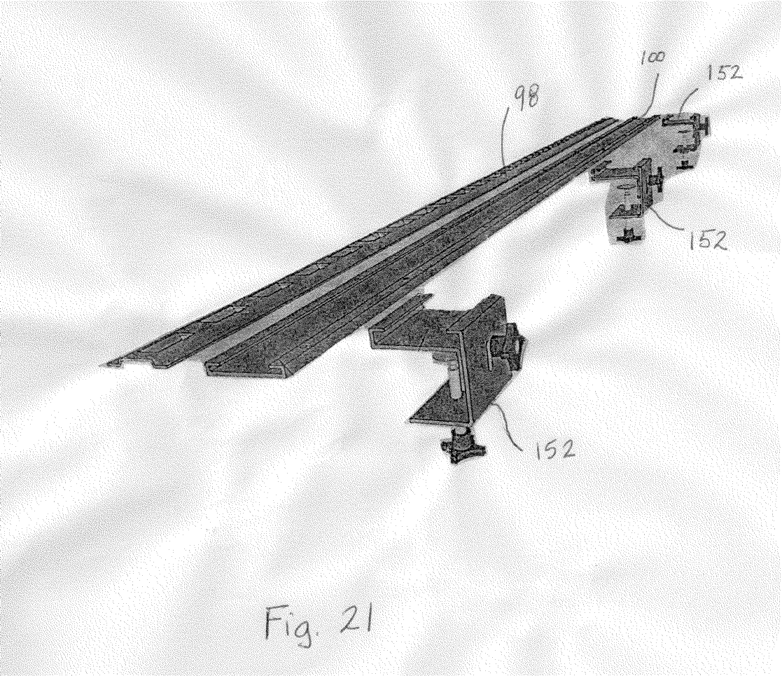

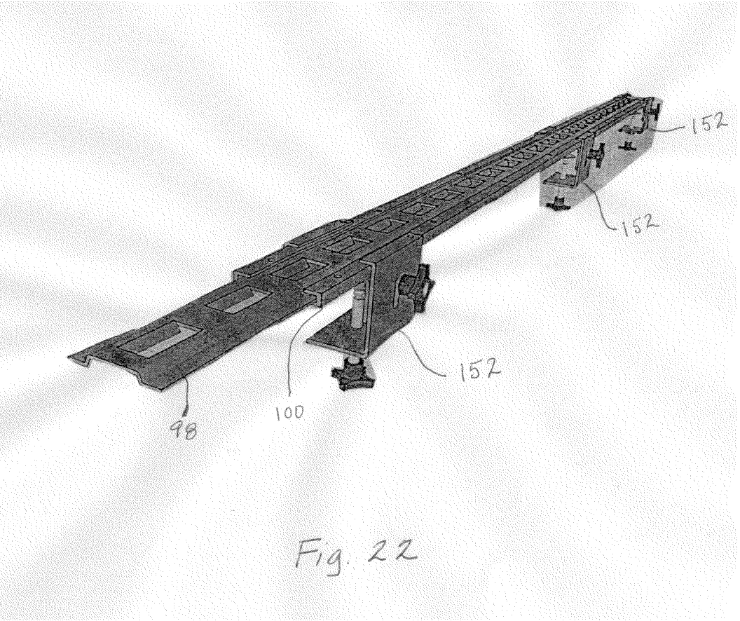

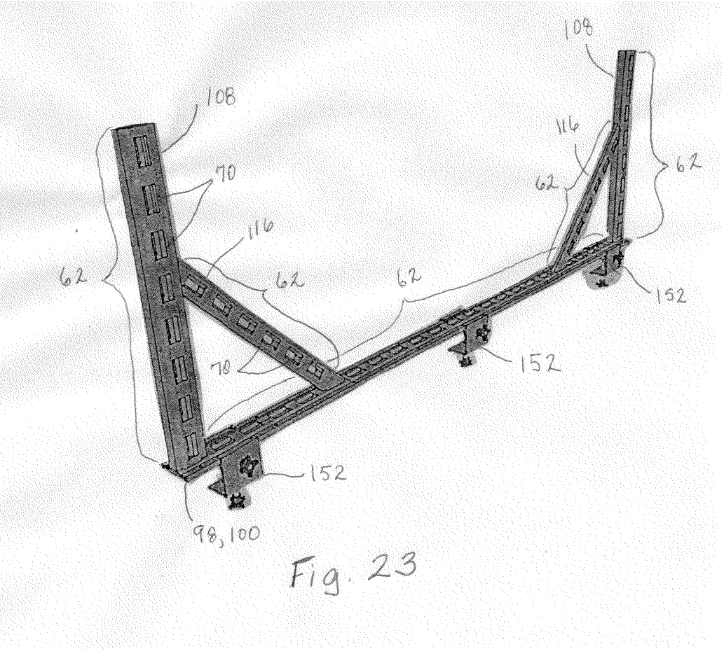

As another feature of the invention, the upstanding support members 108 will also include the pattern of attachment slots 70 along the length or height thereof, preferably on at least two surfaces thereof, such as, but not limited to, a surface 110 facing the truck bed 58, and an outwardly facing surface 112. The support members 108 can be reinforced with diagonal braces 114, and these too preferably include the pattern 68 of attachment slots 70 therealong, also on at least two surfaces thereof, e.g., facing the truck bed, and outwardly facing. The diagonal braces 114 also have or are attached to rails 98 slidably receivable in the C-shape channels 100, preferably incorporated in a single unit with the upstanding support members, e.g., such as by welding to a rail 98 sized to be slidably received in the C-shape channels 100, as best illustrated in FIGS. 23-25. Further in this regard, this rail 98 can include a row of the attachment slots 70 between the upstanding support member 108 and the brace 114, as best illustrated in FIGS. 23 and 24, to provide more attachment points for tie downs and the like. As a result, each side of a rack constructed of the system of the invention can have a large number of possible attachment locations, e.g., 40 to 100, which provides substantial versatility for attachment of items such as tie down straps 74, brackets and the like, to the rack. Each of the side rails 98 can include 20 or more attachment slots 70, e.g., 24 on an 8 foot long rail for a standard length pick up truck bed.

In numerous of the FIGS., it can be observed that the upstanding support members 108 comprise essentially the same rail material as the slotted rails 98, fabricated such as by welding rails 98 together with spacer strips therebetween to create hollow rectangular box beams providing oppositely facing vertical rows of attachment slots 70 providing attachment points for a variety of items essentially along the entire height of the support members 108 which is advantageous, as will be explained. Alternatively, the support members 108 can be constructed of commercially available box beams, with the rails 98 including the patterns of attachment slots 70 mounted along desired surfaces thereof in a suitable manner, such as by fasteners or welding. As another alternative, the support members and other structural elements can have more aerodynamic cross sectional shapes such as a foil shape, if desired. Further regarding the attachment slots 70, they are illustrated as being located on the surfaces of the support members 108 facing the truck bed 58 and the opposite surface, but additionally, or alternatively, can be provided on the forwardly and rearwardly facing surfaces, as desired or required for a particular application, although for purposes of wind drag and noise reduction, it may be better to provide the slots on the sidewardly facing surfaces of the rack structure.

The diagonal braces 114 can be constructed more simply than the support members 108 as illustrated, essentially from two opposing rails 98 welded together, or in the same manner as the support members 108, and, as noted above, will preferably include the patterns 68 of attachment slots 70 along the length of opposite sides thereof. Here, it should be understood that the patterns of attachment slots 70 can be provided on the surfaces of the braces facing the truck bed and the opposite surface, and/or on the forward and rearward surfaces, as desired or required for a particular application, and that the braces can have an aerodynamic shape, such as a foil shape, if desired.

It should be understood that by the interchangeable slidable receipt of the long rails 98 including the pattern 68 of attachment slots 70, and the upstanding support members 108 in the C-shape channels 100, the system of the present invention can be easily and quickly reconfigured, or just removed, to meet a user's changing needs. For instance, just the rails 98 can be used in the C-shape channels 100, or just the upstanding supports 108 can be alternatively or additionally used to form a rack structure, as explained next.

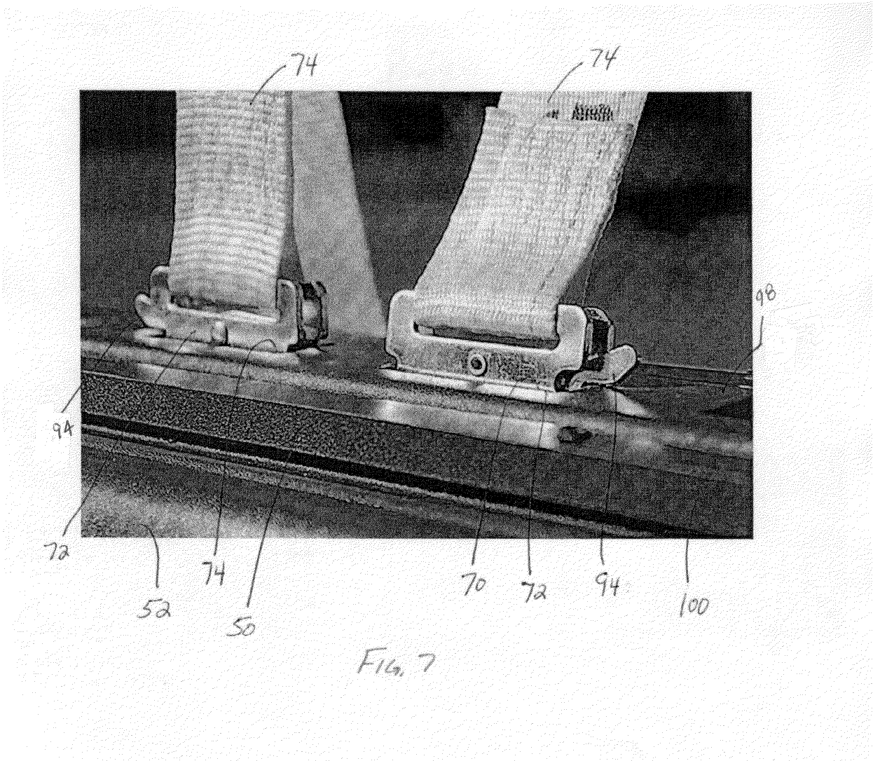

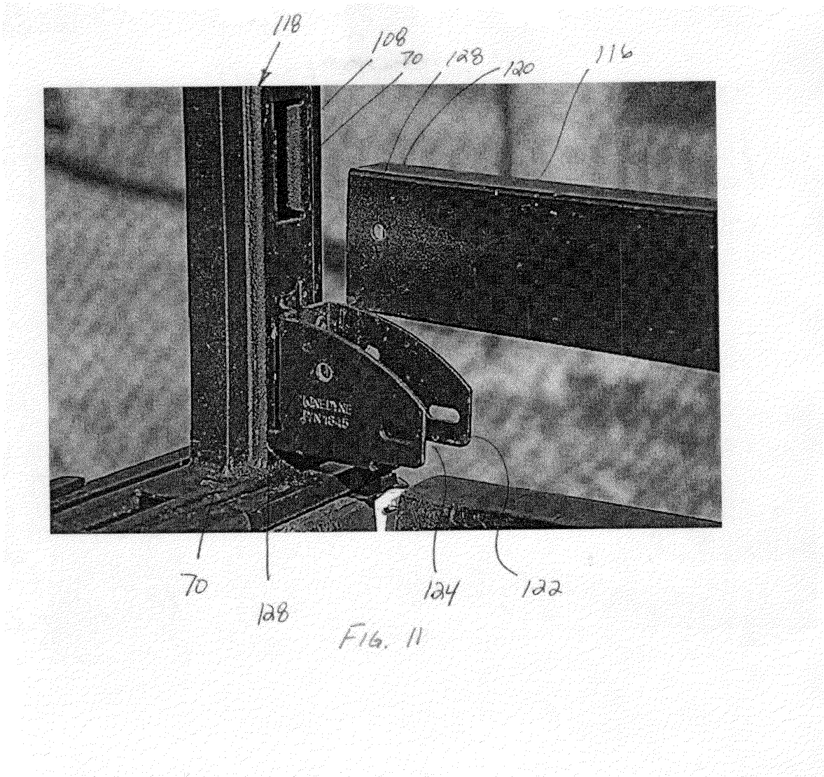

As another aspect of the invention, as best shown in FIGS. 8-12, the system of the invention includes cross members 116 that can be attached to the upstanding support members 108 so as to span a pick up truck bed 58, forming a 3-dimensional rack structure 118. Preferably, the ends 120 of the cross members 116 are configured to attach in the same manner of locking attachment as other items such as cargo straps and the like, the upstanding support members 108, most desirably, using the above described commercially available latching mechanisms 72. As an example, the latching mechanisms 72 can be provided on commercially available stirrup brackets 122 enabling the brackets to be attached at about any desired height on support members 108 of the rack structure, simply by engagement with a convenient slot 70 as shown in FIG. 12. Each stirrup bracket 122 has a receptacle 124 for cooperatively receiving and supporting the respective ends 120 of the cross members 116, which can be suitably retained such as by using locking pins 126 insertable through aligned holes 128 in the brackets 122 and end 120 of the cross member and having retaining wires that extend about the cross member. The cross members 116 can also be telescoping or otherwise adjustable in length, as desired or required for a particular application. Additionally, the cross members 116 can be provided with the patterns of attachment slots 70 along one or more surfaces thereof, to provide additional points for connection of tie down straps 74 or the like. Still further, the cross members can have a more aerodynamic shape, such as a foil shape, if desired.

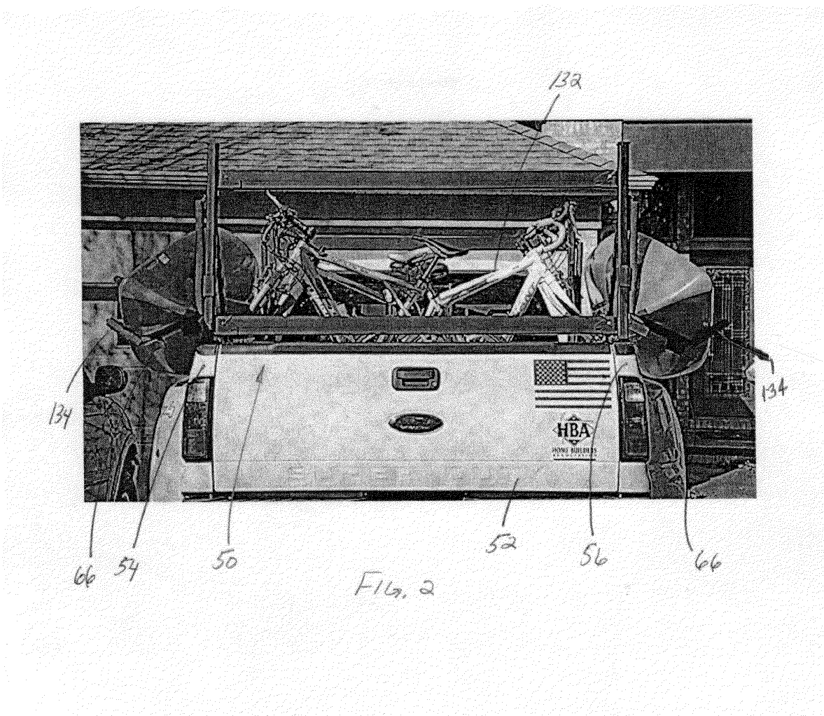

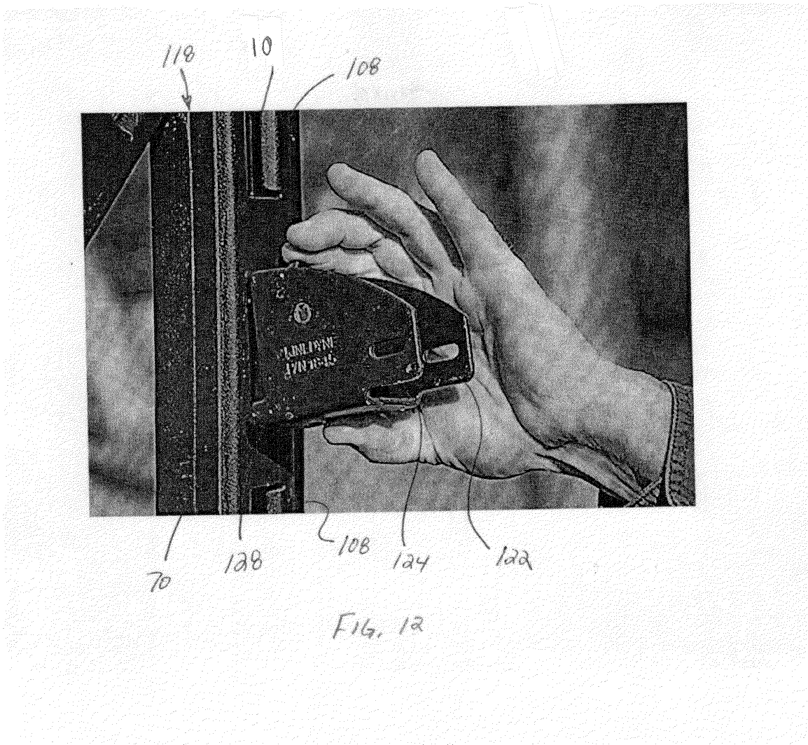

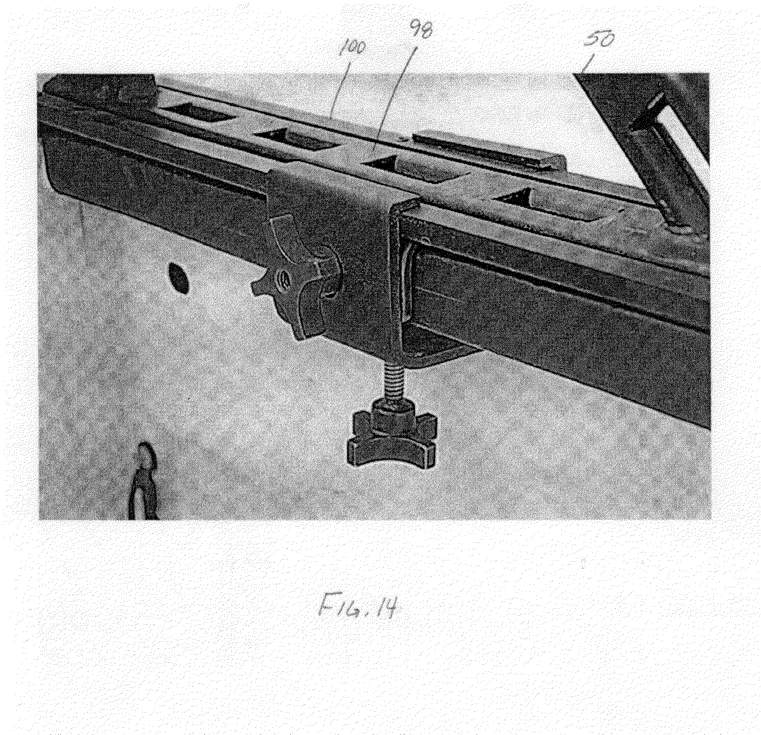

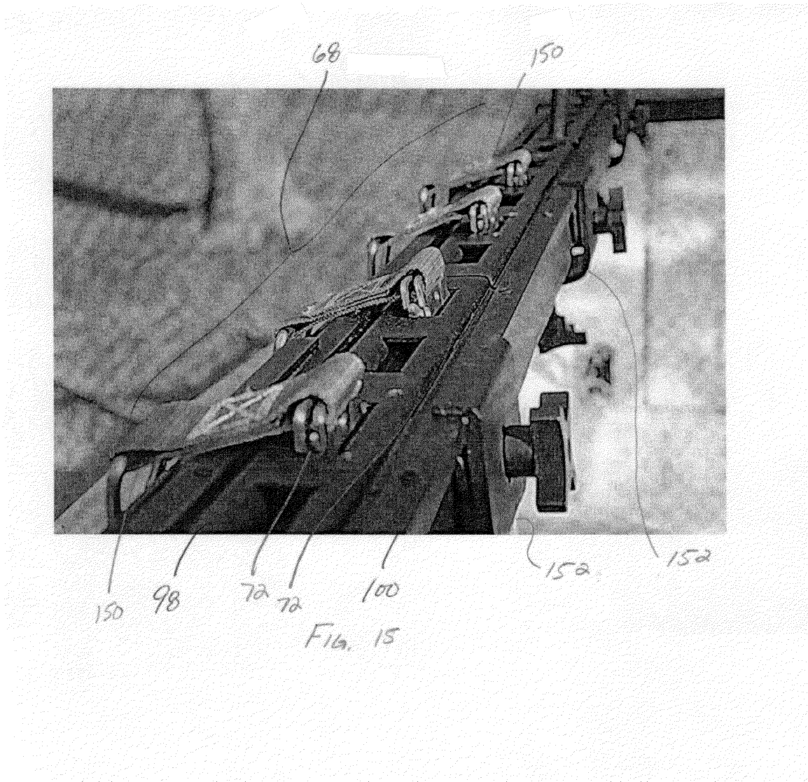

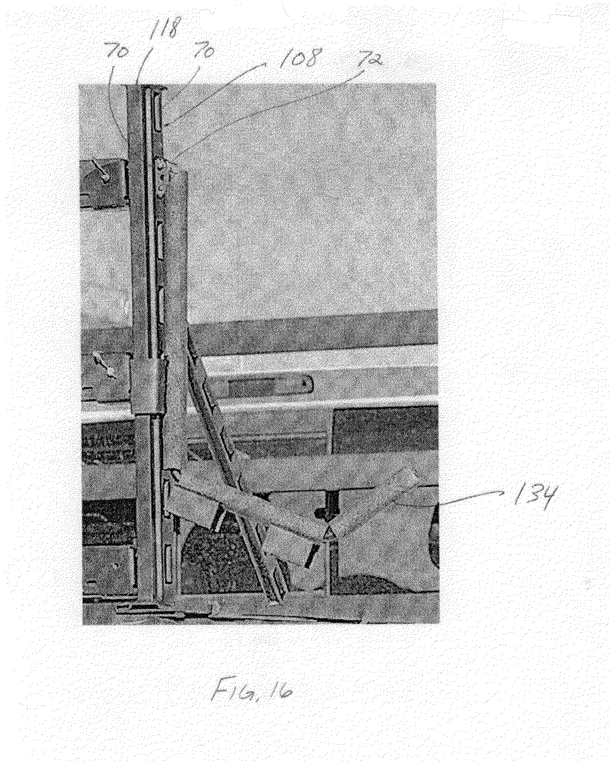

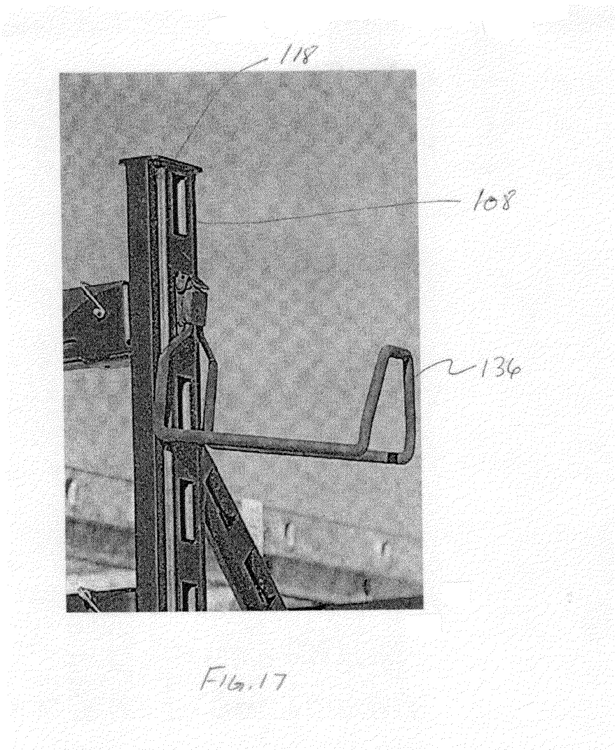

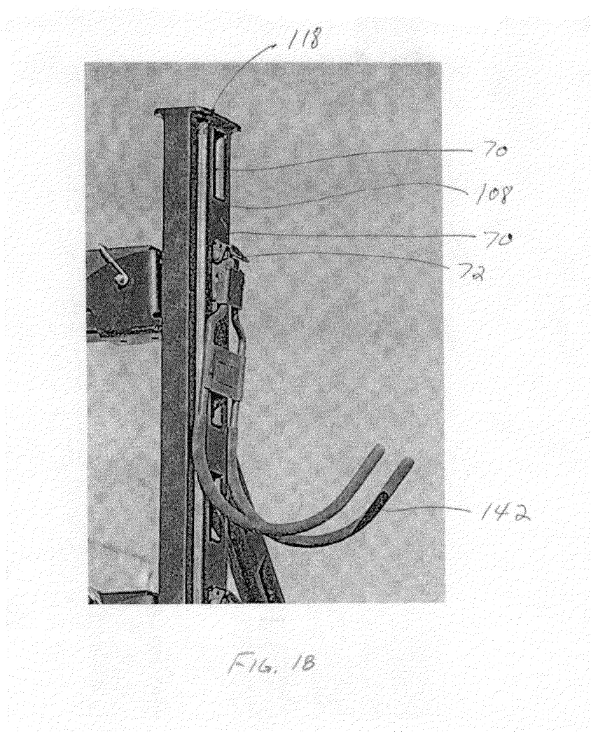

Here, it can be observed in FIGS. 1 and 2, that the system 50 of the invention can be configured for carrying and securing other items, such as canoes, kayaks and other types of boats 66. As also illustrated in FIG. 13, the system can include clamps 130 or other attachment devices for the forks of bicycles 132, for instance, on or attachable to the side rails 98, such that several bicycles 132 can be carried in the bed 58 of a truck in side by side relation. For this purpose, clamps 130 can include latching mechanisms 72 attachable to any of the attachment slots 70 of the rails 98 or cross members 116, if so equipped. It can be observed in FIGS. 2 and 16 that this capability can be combined with a boat carrying capability, both on the cross members 116 if used (FIG. 2), and also using special J shape boat hooks 134 that can include latching mechanisms 72 for attachment to the attachment slots 70 on the upstanding support members 108 (FIG. 16).

Similarly, the rack configurations of the invention can include special fittings for carrying other items, such as J-shape hooks 136 (FIG. 17) configured for carrying a ladder or ladders, or a beverage jug, on the side of any of the support members 108; and cord and rope carrier 142 (FIG. 18), each of which fittings will include a locking mechanism 72 for locking attachment to any of the attachment slots 70 of the upstanding rack structure 118. Thus it should be understood that by virtue of the provision of numerous of the attachment slots 70 on the upstanding support members 108, ladders 62, boats 66, and a variety of other items can be supported, external to or within the 3 dimensional rack structure 118 by attachment of latching mechanisms 72 to any of the slots 70.

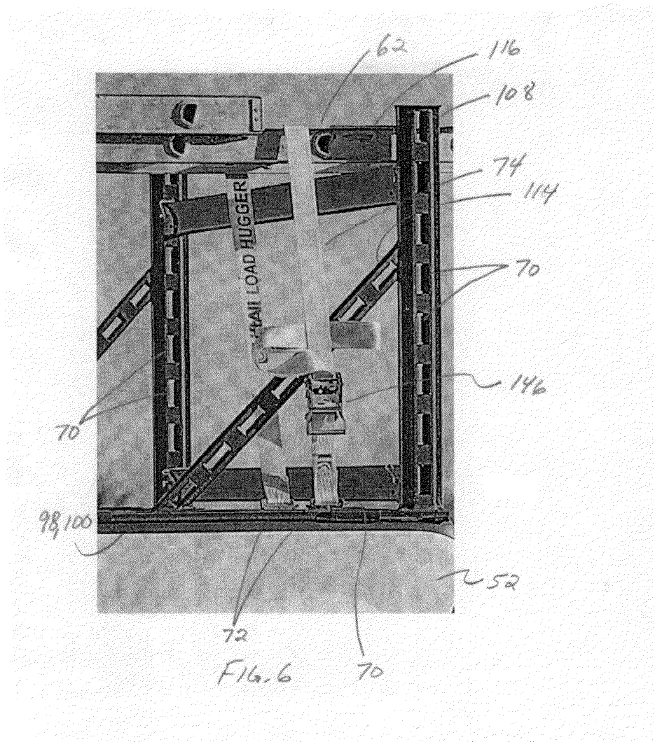

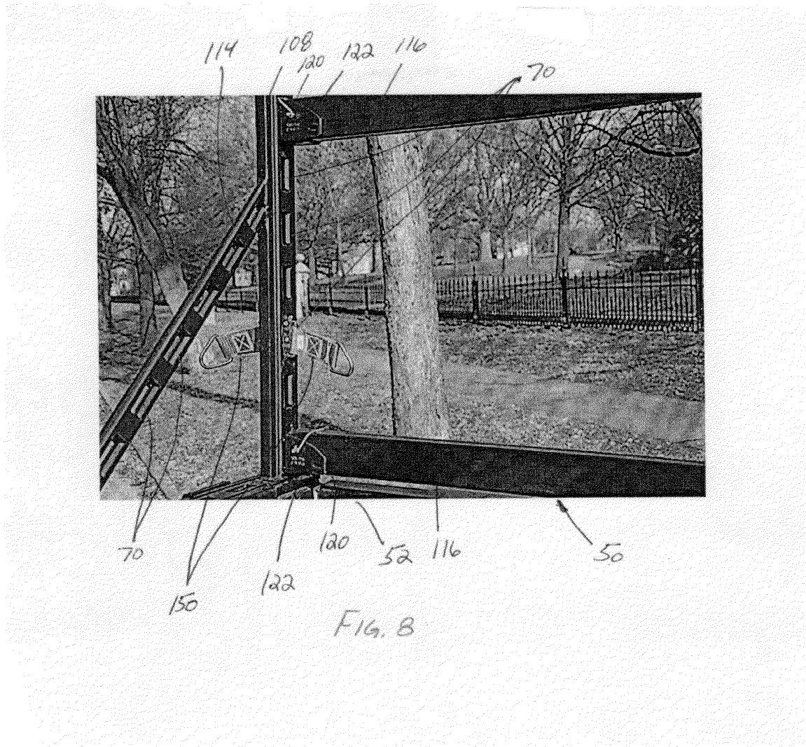

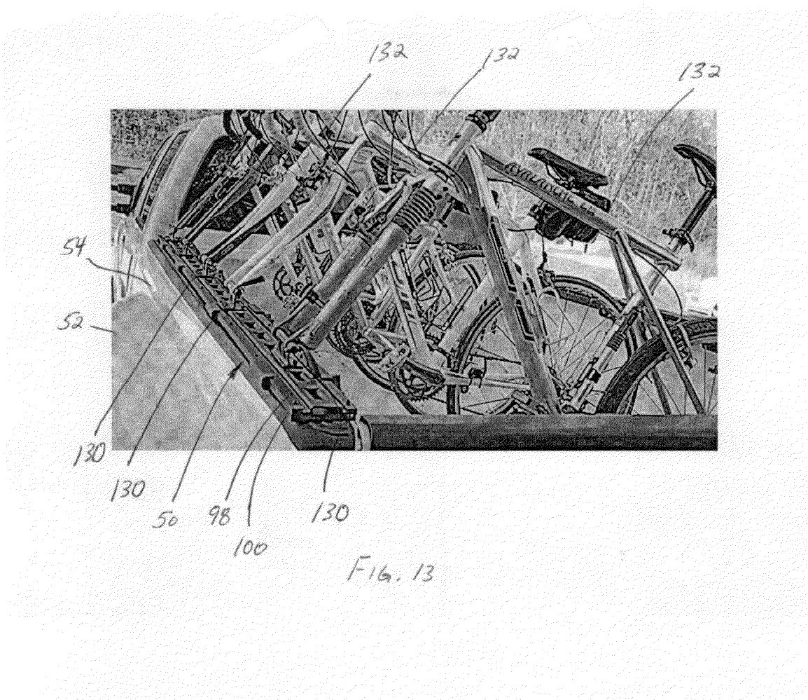

Various of the FIGS. show representative embodiments of commercially available ratcheting cargo or tie down straps 74, and how they can be used for securing loads and items to the elements of the invention. These straps 74 can be commonly purchased including a latching mechanism 72 and ratcheting mechanism 146 on one end and a hook or another mechanism 72 on the opposite end, as well as in a variety of other configurations. Cargo ring straps 150 having a latching mechanism 72 on one end and a ring on the opposite end are also widely available for purchase. It can be observed that a ladder, boat, lumber, or virtually any large and cumbersome item can be secured in the bed 58 of a vehicle to the side rails 98 on the tops of the bed sides, at any location or locations along the length thereof using these types of commonly available straps, as generally illustrated in FIG. 15. As an example, this can be accomplished by attaching the latching mechanism 72 of each of the straps 74 as generally illustrated in FIGS. 6 and 9; looping the other end of the strap about the item to be secured; attaching latching mechanism 72 of the opposite end to another attachment slot 70; and tightening the strap by operating the ratcheting mechanism 146. Here it can be envisioned that this is quickly and easily done, and that the location of the large number of attachment slots 70 on the bed sides makes this convenient, as the latching mechanisms 72 are attached at a convenient location for a person standing on the ground next to the truck bed, and the ratcheting mechanisms 146 of the straps 74 will be at about head level, so as to be conveniently and easily operated.

As an additional advantage, because each attachment slot 70 of the present system 50 is discrete, it provides a fixed location for the attachment of a strap 74, and the strap will not be subject to lateral slippage and resulting loosening, as is possible when the strap is wrapped around a structural element such as a rail or upstanding support member, or is secured in a slot using some kind of sliding fitting such as the sliding rings of the TracRac system discussed above. When it is desired to strap loads in a more oblique manner, e.g., extending forwardly or rearwardly at a diagonal to horizontal, the attachment slots 70 on the diagonal braces 114 can be advantageously employed, to reduce the possibility of load shifting during braking, acceleration, and turning of the vehicle, for increased security. By securing a load using this feature, the ratcheting straps 74 can be aligned generally perpendicular to the brace 114, and tightened without slipping or twisting of the strap. Again, because the braces 114 are located at about chest level of a person standing on the ground beside the truck, attachment of latching mechanisms 72 and operation of ratcheting mechanisms 146 is easy and convenient. Alternatively, either end of a strap can be attached to a brace, and the opposite end attached to any of the other elements of the rack structure, as illustrated in FIG. 9.

Because the attachment slots 70 are located along the length or height of the support members 108, the cross members 116 can be lockably attached thereto at any desired height above the bed, and more than one cross member 116 can be attached to a pair of support members 108, to provide carrying capacity at more than one level. Thus for instance, two support members 108 at the front and/or rear of a truck bed 58 can have cross members 116 extending therebetween in spanning relation to the space above the bed, at different levels, to provide carrying capacity at the different levels. As an example of an advantage of this, different construction materials and/or supplies can be carried on the respective cross members 116, so as to be segregated and separately accessible, as desired or required for a particular application.

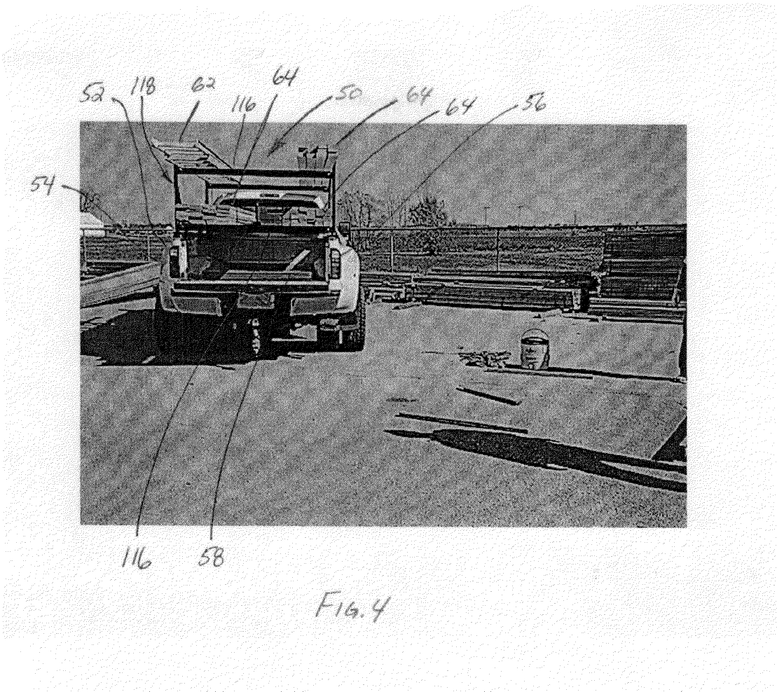

As a better illustration, in FIG. 4, one rack configuration of the present invention is shown, having upper front and rear cross members 116 spanning the truck bed 58 adjacent to the upper ends of the upstanding support members 108, and lower cross members 116 at a lower location, just above the walls 54, 56 of the bed. It can be observed that by providing cross members 116 at a level just above the bed walls, the bed is left free for carrying other supplies or equipment, which can be placed in, and removed from, the bed area without moving or disturbing the items carried on the lower cross members 116. Also, because attachment slots 70 are located along the height of the support members 108, cross members 116 can be securely attached at almost any vertical location along the height of the rack structure 118. The ease of use of locking mechanisms 72 also allows quickly and easily removing and reinstalling cross members 116, as desired or required to reconfigure the rack structure for a new load.

To illustrate the advantage provided by this versatility, it can be seen that several varieties of lumber 64 (or any other suitable items) can be carried in a segregated manner at different locations on the rack, with additional items carried in the bed of the truck, all being secured using straps 74 attached to the side rails 98 in the above described manner, and separately accessible so that removal of any of the carried items can be achieved without rearranging or removing other items. This has been found to increase productivity, and reduce damage to the carried items.

FIGS. 21-28 and 30-34 show several embodiments of apparatus for mounting the side rails 98 to the side walls 54, 56 of a pick up truck or other base structure, and also an alternative rail construction. In particular, FIGS. 21-24 illustrate the previously shown and described C-shape channel 100 configured for extending substantially the entire length of the side wall of the truck bed on which it is to be mounted, and also the entire length of the rail or rails 98 to be used therewith.

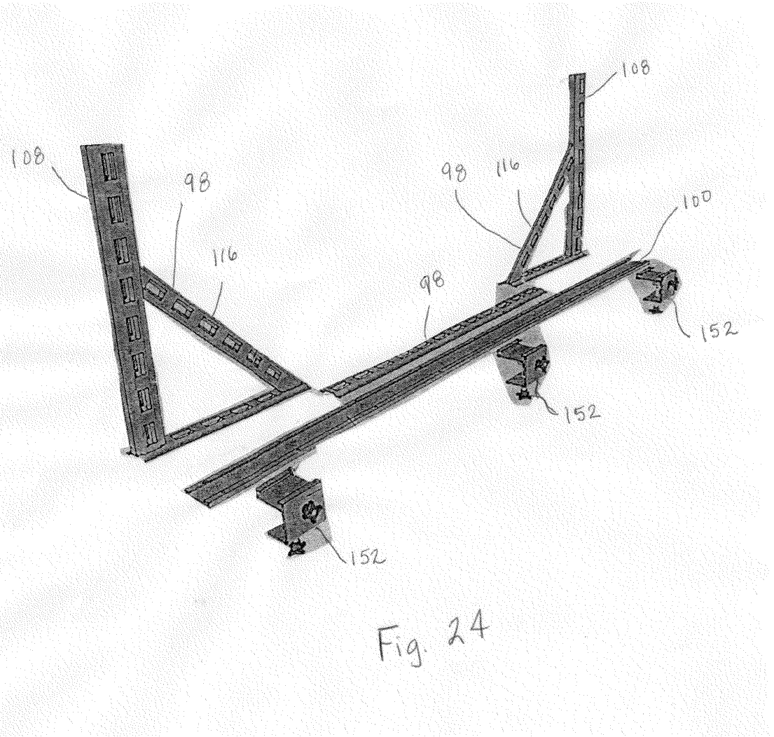

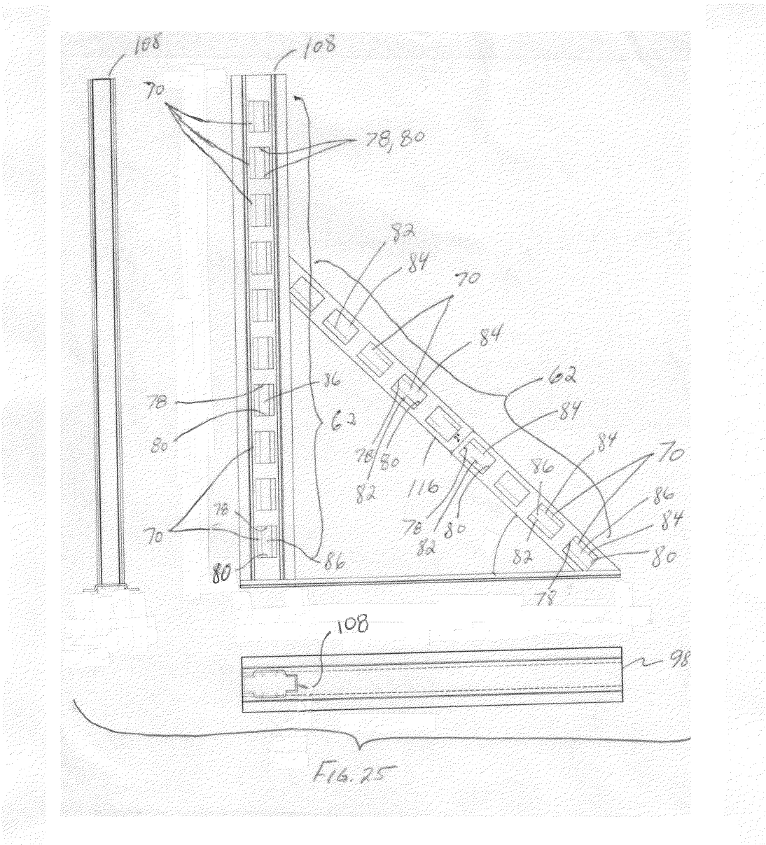

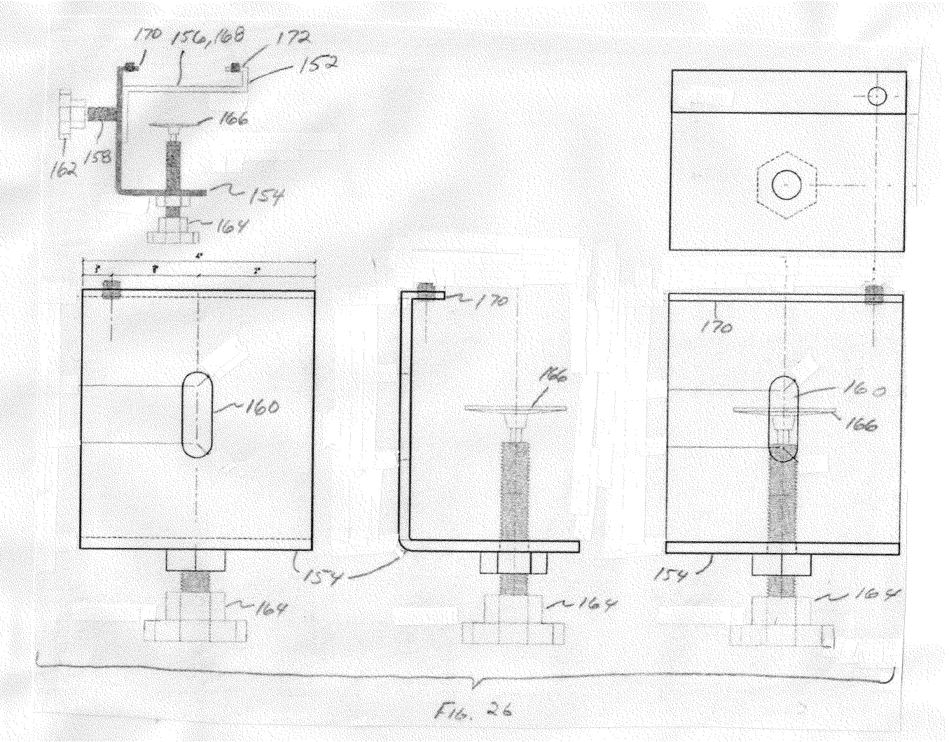

In FIGS. 26-28, a preferred manner of mounting C-shape channels 100 utilizes a bed clamp 152 that is adjustable for fitting different bed side walls, is illustrated. Each clamp 152 has a base 154 and an adjustable member 156 that slidably attaches to base 154 using a threaded stud 158 attached at one end, e.g., by welding, to adjustable member 156 and which passes through a slot 160 in base 154. A nut 162 threadedly engages stud 158 and can be brought to bear against base 154 to hold adjustable member 156 to base 154 at a desired slidable position. Base 154 additionally includes a threaded screw 164 threadedly engaged therewith and extending toward the under side of a flat section 168 of adjustable member 156. The upper end of screw 164 has a swivel pad 166 located below a flat section 168 of adjustable member 156. Pad 166 can include a soft cover of a rubber or plastics material if desired.

To use clamp 152 in the manner illustrated in the previous FIGS., nut 162 is loosened to allow relative slidable movement between base 154 and adjustable member 156. The underside of flat section 168 of the adjustable member 156 is positioned on the upper surface of a side wall or other location on which the clamp is to be mounted, such as wall 54 or 56. The nut 162 is then tightened, and screw 164 tightened to bring pad 166 to bear against the underside of the upper surface of the side wall. If desired or required, shims or wedges can be placed between the underside of flat section 168 and the surface on which it is to be mounted. When screw 164 is tightened sufficiently, clamp 152 will be securely mounted. If desired, multiple clamps 152 can be loosely placed on a side wall or other surface, to allow lateral movement for aligning the clamps, and then screws 164 tightened. C-shape channels 100 are now positioned in aligned relation for receiving rails 98, which are also secured in position with set screws 102 or other convenient apparatus, the attachment of the rails, and/or entire rack structure 118 being accomplished in minutes, using just a hand driver 104, as illustrated in FIG. 28.

In FIGS. 29-34, alternative embodiments of apparatus for mounting rails 98 of the invention utilizing a toggle bolt 174, are shown. Toggle bolts 174 are insertable through a hole in the surface onto which the rail is to be mounted, the toggle bolt being operable in the well known manner to resiliently retract laterally for passage through the hole then automatically extend laterally outwardly so as to be capable of being brought to bear against the underside of the surface when the bolt is tightened. The alternative mounting apparatus include a C-shape channel 100 having a hole therethrough for receiving a toggle bolt 174 and adapted for slidably receiving a rail 98 in the above described manner; a flat plate 176 similarly having a hole for receiving a toggle bolt 174, and configured for use with a rail 98 having lips 170 and 172 forming a passage for slidably receiving the edges of the flat plat 176; and a J-shape plat 178 welded to a rail 98 and adapted for fitting about a lip on the top of a side wall to which it is to be mounted. In each of the first two constructions lips 170 and 172 include set screws 102 that can be tightened for securing the rail 98 in positioning the C-shape channel or to the plate.

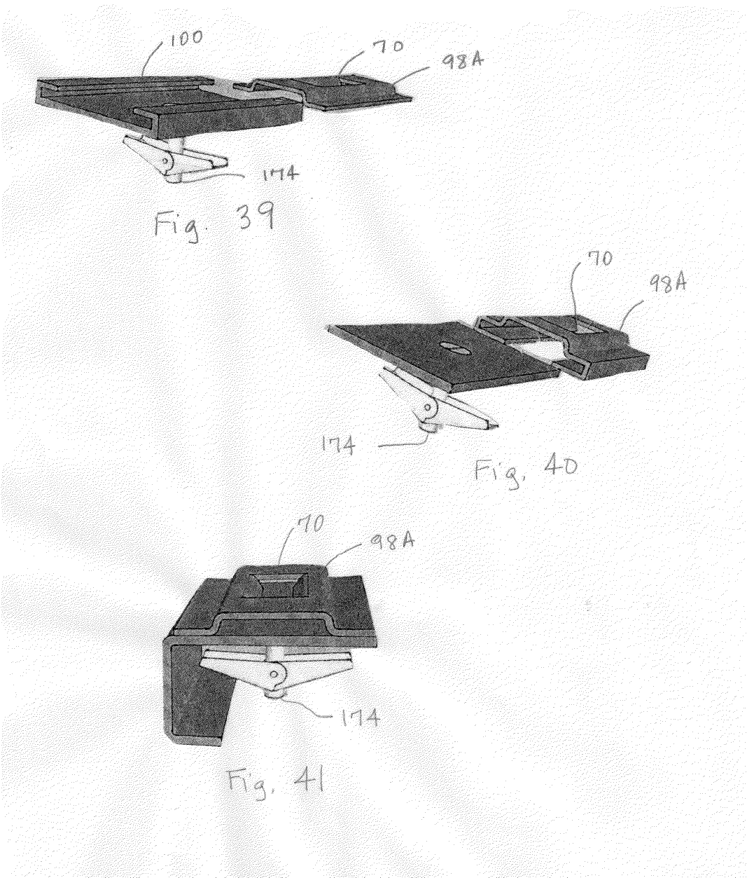

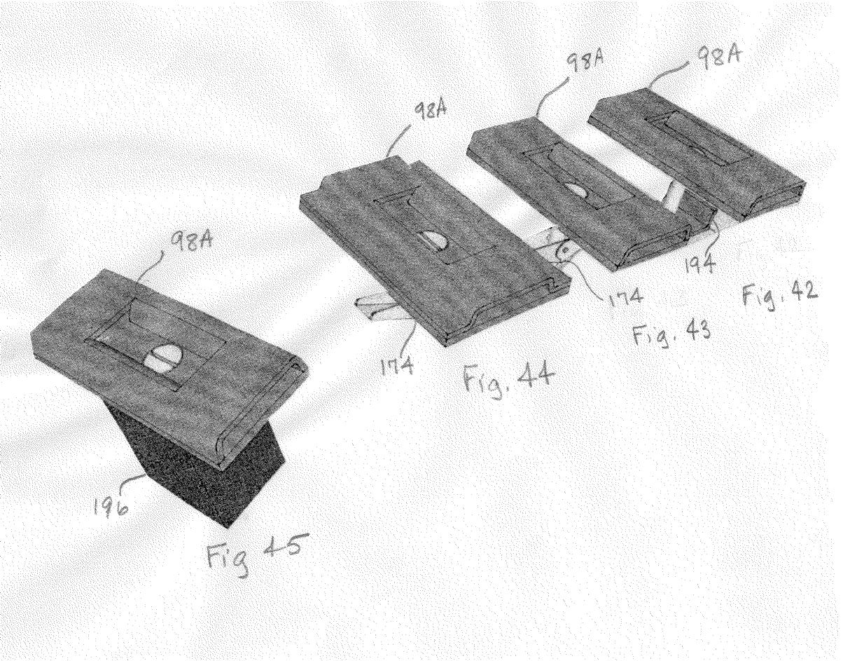

Referring now to FIGS. 35 through 45C, several additional embodiments of apparatus and systems of the invention for support and attachment of loads to a vehicle are shown. More particularly, in FIGS. 35 through 38 several elongate embodiments of the invention are shown, which advantageously allow attachment of loads at a variety of locations along a structural element of a vehicle are shown. In FIGS. 39 through 45C, shorter embodiments are shown.

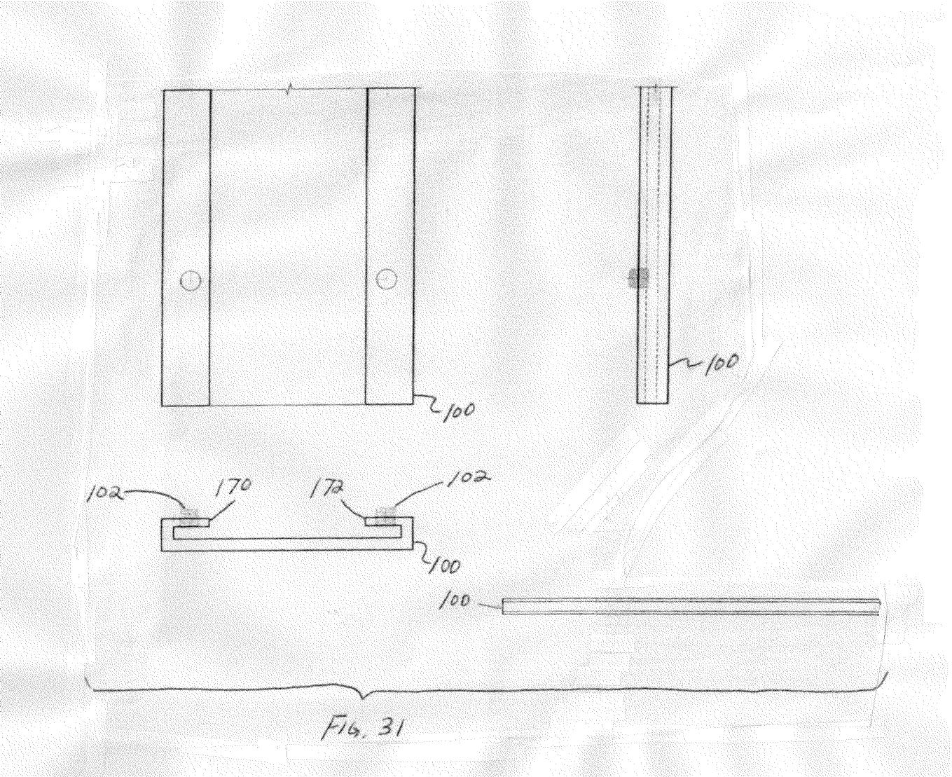

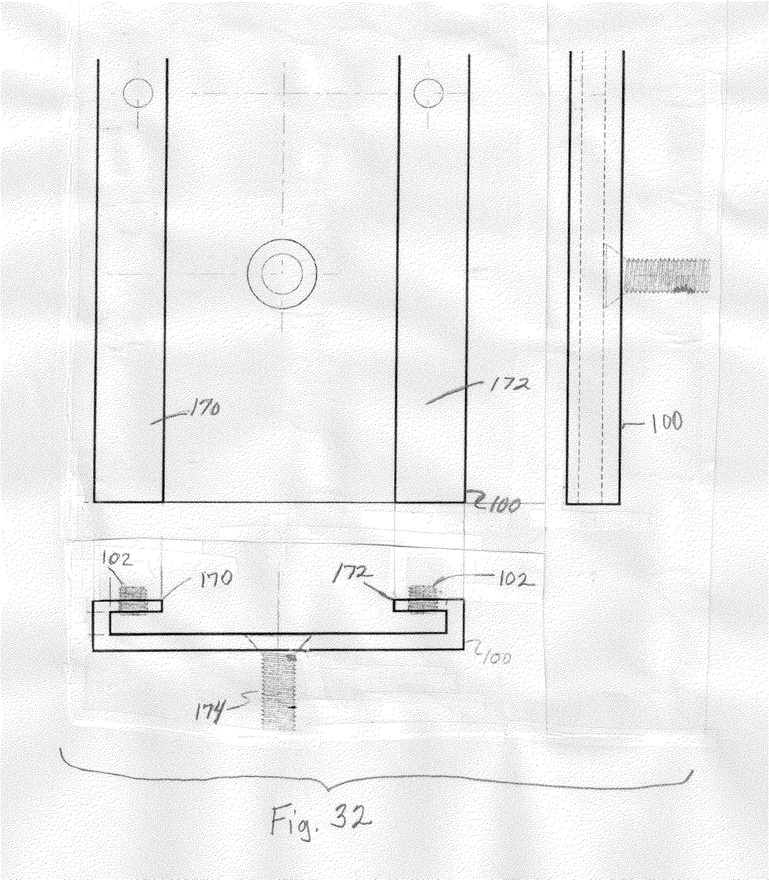

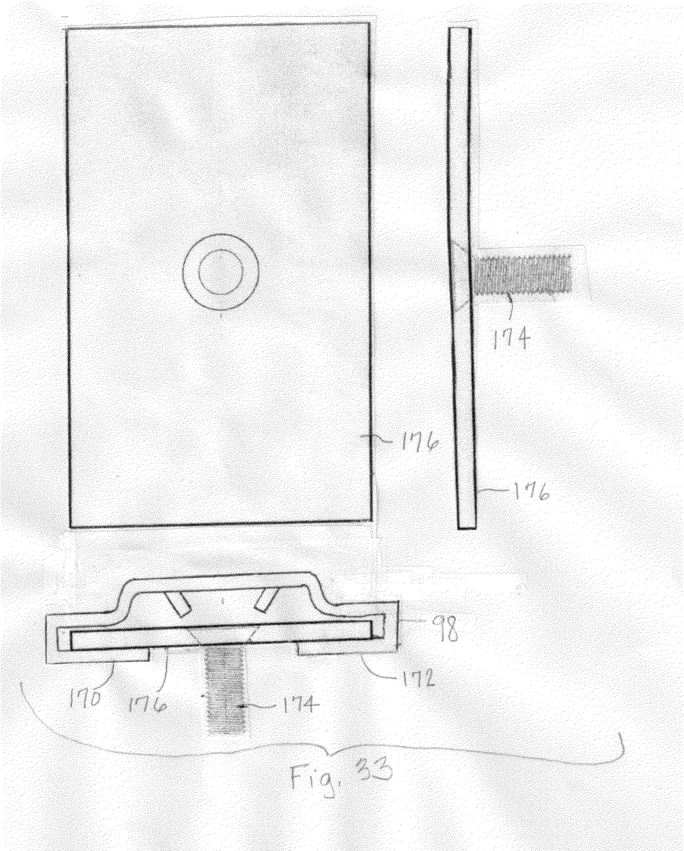

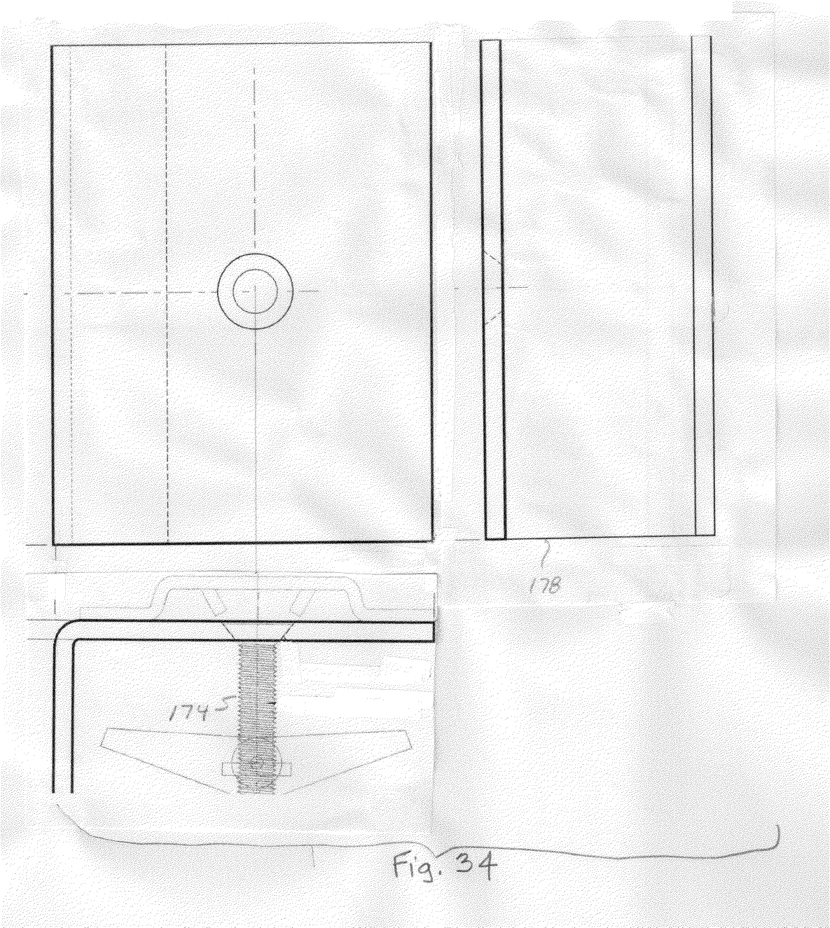

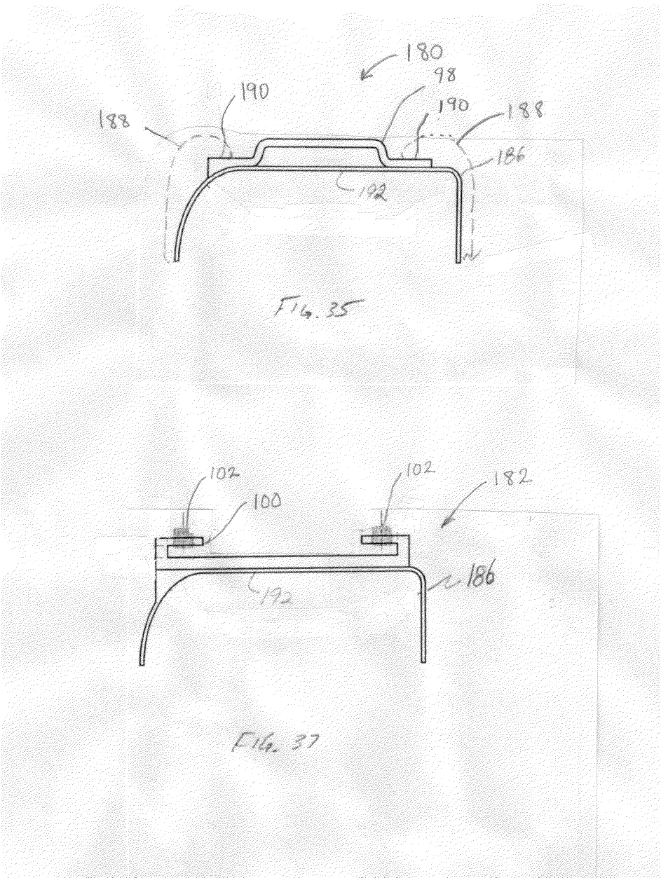

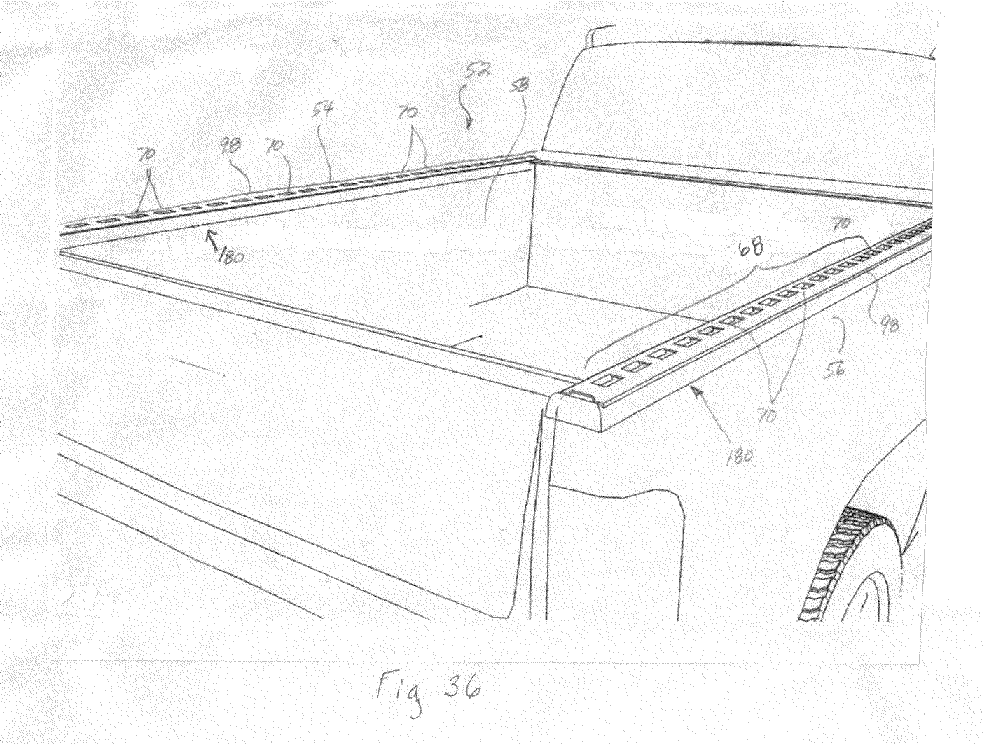

Referring more particularly to FIGS. 35 through 38, two systems 180 and 182 are shown, which are configured for use with a vehicle 52 which is a representative pick up truck. Systems 180 and 182 can be configured for quick and easy installation on a variety of vehicles, particularly on the side walls 54 and 56 of a pick up truck bed 58, or can be permanently installed at time of manufacture of the vehicle, e.g., as shown in FIG. 36A, or added as an accessory. Systems 180 and 182 can be used with a variety of connecting devices for securing a variety of loads, and provide a multitude of discrete attachment points for securing the loads, particularly for ratcheting straps and the like as illustrated in the previous FIGS.

The systems 180 and 182 of the invention can be configured for just securing loads to the side walls 54 and 56 of a pick up truck bed 58, or can be configured for use with an upstanding rack structure for carrying loads such as ladders, lumber, boats, and the like. To facilitate this versatility, a central component of the apparatus and systems 180 and 182 of the invention is an elongate array or pattern 68 of attachment slots 70 configured and operable for attachment of fittings or locking or latching mechanisms 72 for securing items such as ratcheting tie down straps 74, cross members 76, and the like, as illustrated in various of the other FIGS.

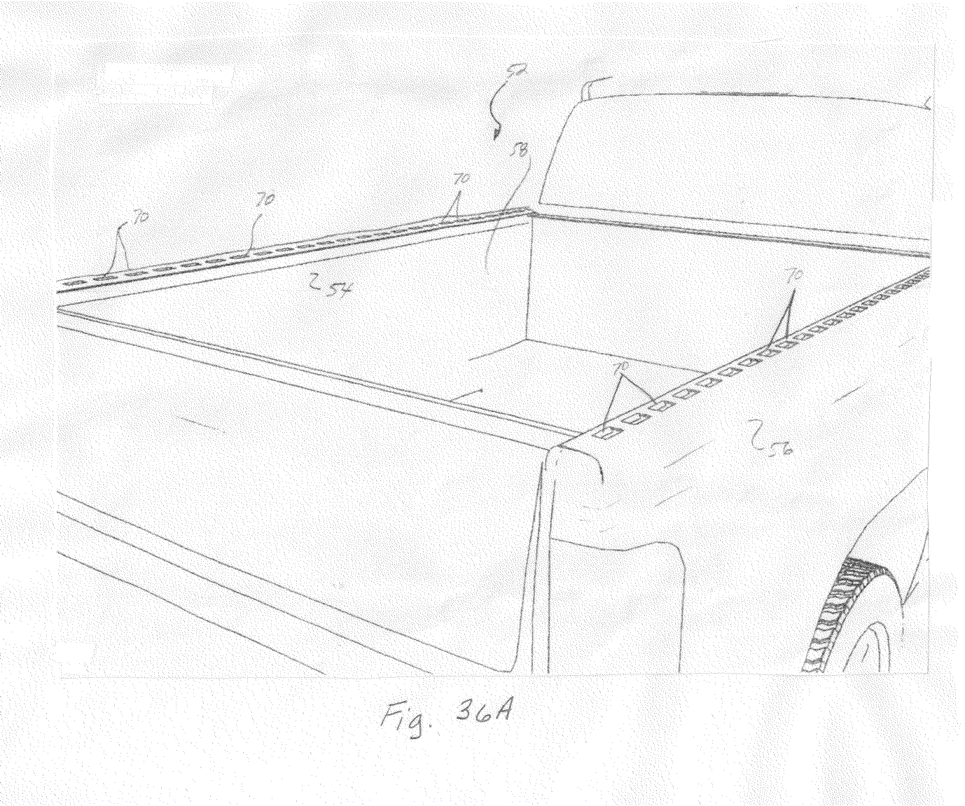

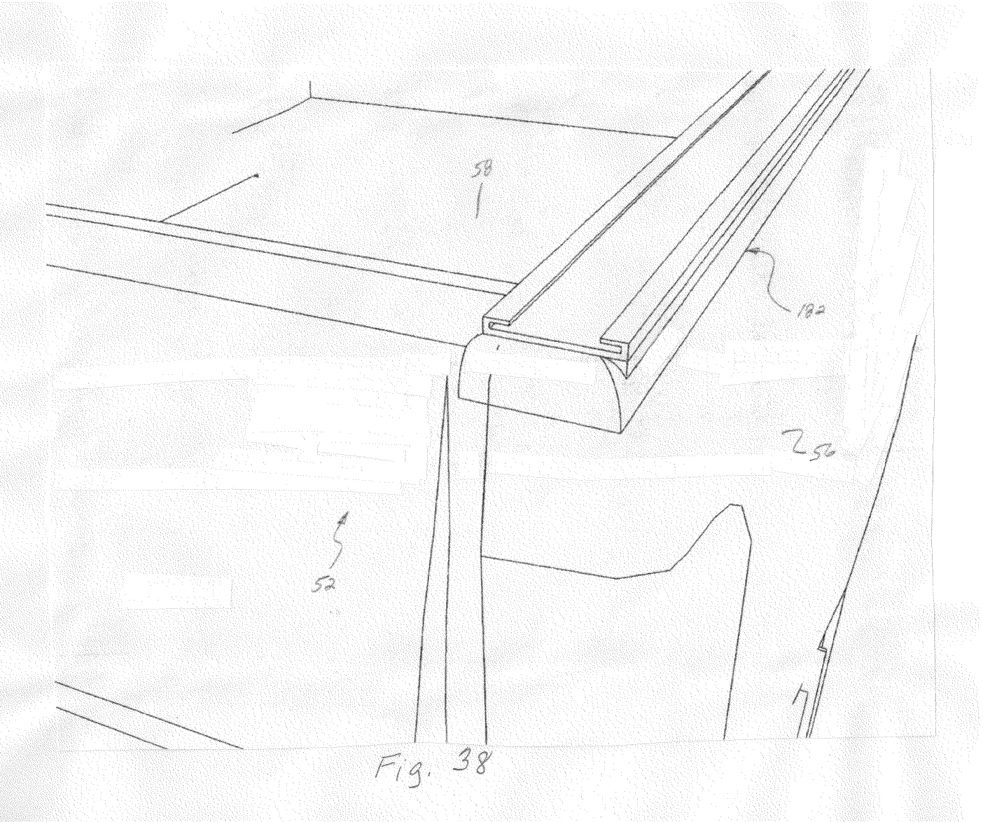

Referring variously also to FIGS. 42, 42A through 42C, 43, 44, 45, and 45A through 45C, representative short rails 98A are shown, with attachment slots 70 of uniform configuration, each having an elongate rectangular shape bounded on the opposite longitudinal ends by opposing edges 78 and 80, with lips 82 and 84 along the opposing edges of the slot 70 extending between the longitudinal ends for stiffening and strengthening the structure in which the slots 70 are located. The slots 70 can be configured in side by side or end to end relation, end to end being preferred and illustrated. Beneath each attachment slot 70 is a space 86, configured to receive a locking bar 88 of a locking or latching mechanism 72 engageable with the longitudinally opposing edges 78 and 80 bounding the slot 70, e.g., as shown in FIGS. 6 and 7. Such attachment slots 70 and latching mechanisms 72 are preferably of well known construction, such as illustrated in Klekar U.S. Pat. No. 4,033,268, issued Jul. 5, 1977. Again, the latching mechanism 72 is securely fixed or locked to the structure bounding the attachment slot 70, until manually released by retraction of the spring biased end of the locking bar of the mechanism. These attachment slots 70 are commonly provided on rails located along the walls and floors of commercial truck boxes and trailers and a wide variety of devices such as ratcheting tie down straps 74, cords, chains, and the like, shown in various of the previous FIGS., include the illustrated latching mechanisms 72 used in the apparatus and systems 180 and 182 of the invention. As an advantage, the ratcheting tie down straps 74 and other tie down devices are widely commercially available and a user is not limited to proprietary devices for securing loads.

In several embodiments of the invention, the arrays or patterns 68 of attachment slots 70 are preferably incorporated along rails 98 configured to be mounted to or otherwise incorporated with the tops of side walls 54, 56 of a pick up truck bed 58. In the embodiments of FIGS. 35, 36 and 36A, rails 98 are integrated into an elongate cap structure 184 that is mounted on or integrated with the upper surface of the side wall 54 or 56. To facilitate this, the rail 98 will be attached to or incorporated into an elongate top cap 186 of sheet metal or plastics that covers or comprises the upper surface of the associated wall 54 or 56. As a non-limiting example, rail 98 can be welded to top cap 186. As another non-limiting example, rail 98 can be fastened to top cap 186. As another example, top cap 186, for instance if of plastics material, can be molded about longitudinal peripheral edges of rail 98, or can capture the edges of the rail, or include a slot for slidably receiving the rail, as desired or required for a particular application, and as generally illustrated by lines 188 about edges 190 of the rail. As still another example, rail 98 can be formed in or as the top of a side wall 54 or 56 when manufactured, as illustrated in FIG. 36A. If mounted on the top of a wall 54 or 56, top cap 186 can have a concave or similar shape bottom surface 192 that preferably at least generally conforms to the shape of the upper surface of the wall, so as to be securely held thereon in a suitable manner, e.g., using fasteners, clamps, or the like.

Referring more particularly to FIGS. 37 and 38, apparatus of system 182 incorporates an elongate C-shape channel 100 extending along the top of the side wall 54, 56, configured for receiving rails 98 (FIG. 36) and securable using simple elements such as set screws 102 tightenable by hand using a driver or the like, enabling the rails 98 to be quickly and easily installed and also removed, which can be desirable for a variety of purposes, including for reconfiguring the system in different manners for carrying and/or securing different loads. In this regard, it is contemplated that the rails 98 can be provided in different lengths, including that match the length of the C-shape channel 100, or smaller lengths, for instance, 1 or 2 foot lengths. C-shape channel 100 incorporates top cap 186 of sheet metal or plastics that covers or comprises the upper surface of the associated wall 54 or 56 in the above described manner, and top cap 186 can have a suitably shaped bottom surface 192 for securely mounting in mating relation to the top surface of a wall, as also described above.

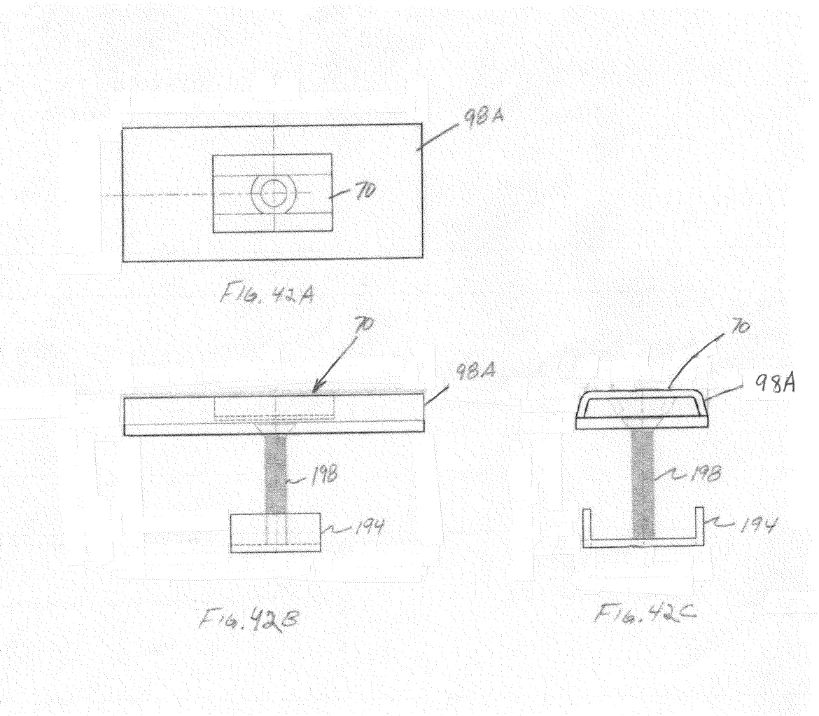

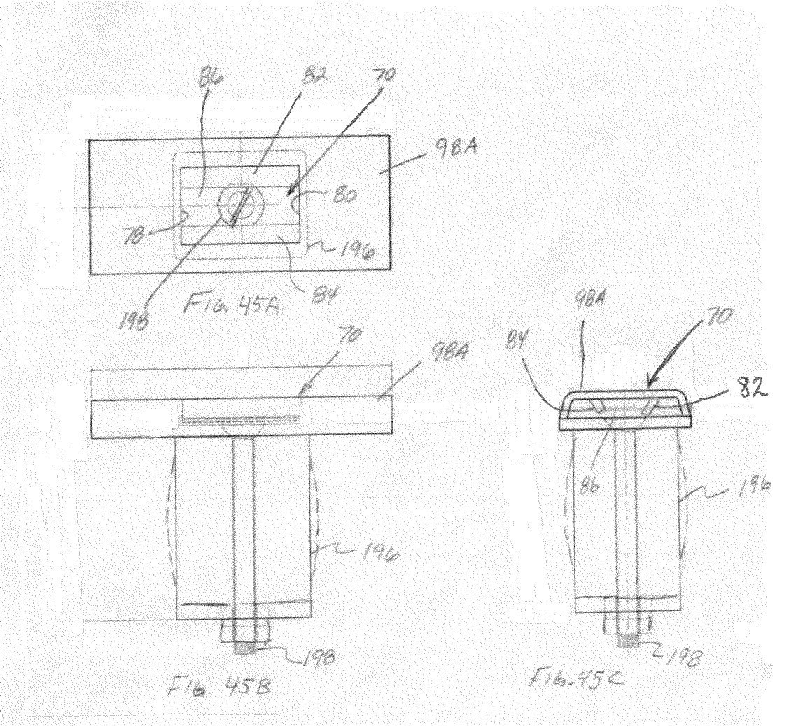

Top caps 186 of both systems 180 and 182 can be secured as variously shown in FIGS. 39 through 45C using fasteners, such as toggle bolts 174; incorporated into the side wall as an OEM item; clamped using clamps 194 tightenable using a draw bolt 198; or brackets or clamps such as expanding clamps 196 using resiliently expandable plugs of rubber or rubbery material received in stake pockets of the side wall and expanded (see dotted lines) by tightening draw bolts 198 (see FIG. 45C). The C-shape channels 100 can also be attached to the front wall and/or rear wall or gate of a pick up truck, as desired for a particular application. The C-shaped channels 100 are configured to slidably receive mounting ends of upstanding support members of the rack components of the system. These will also be secured in position in a simple manner, such as using set screws threadedly received in threaded holes at locations along the channel 100. The upstanding support members will typically be located at the front and rear ends of the side walls 54, 56 of a pick up truck bed 58, in the manner of conventional ladder racks and the like, but can be located at any point along the C-shape channels 100. In a representative combination configuration of the invention, upstanding support members will be located at the front and rear ends of the C-shape channels 100, and shorter rails 98 including the attachment slots 70 along the length thereof will be located in the C-shape channels 100 between the upstanding support members 108, to provide a large number of attachment locations for straps and the like between the support members, as illustrated in previous FIG. 24.

Referring again to FIGS. 39 through 45C, the load securing capability of the invention can be incorporated into short rails 98A including just one or a small number of the attachment slots 70. Rails 98 can be securely attached or mounted on the upper surface of a side wall 54, 56 (FIGS. 36, 38), in a variety of ways, including any of those described above, namely, using a fastener, such as a toggle bolt 174; incorporated into the side wall as an OEM item; clamped using a draw bolt clamp 194 or an expanding clamp 196 (received in stake pockets of the side wall and expanded by tightening draw bolts 198, as illustrated in FIGS. 45B and 45C). As a result, for instance, rails 98A can be located in association with any of the stake pockets or holes of a wall, if desired.

In light of all the foregoing, it should thus be apparent to those skilled in the art that there has been shown and described a LOAD SUPPORT AND ATTACHMENT APPARATUS AND SYSTEM FOR A VEHICLE. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. A vehicle load support and attachment apparatus, comprising:
an elongate rail incorporated into or onto an upper portion of a side wall bounding one side of a bed of the vehicle, the rail having a plurality of discrete attachment slots at closely longitudinally spaced locations therealong, each of the attachment slots being configured to receive a locking mechanism, and defined and bounded by surfaces configured to releasably engage the locking mechanism for securing an item to the rail.

2. The apparatus of claim 1, wherein each of the attachment slots is elongate and oriented to extend longitudinally in a longitudinal direction of the rail.

3. The apparatus of claim 1, wherein the rail is integral with the top of the side wall.

4. The apparatus of claim 1, wherein the rail is integrated into an elongate top cap structure mounted on the upper surface of the side wall.

5. The apparatus of claim 4, wherein the top cap structure comprises a sheet metal or plastics material and the rail is metal.

6. The apparatus of claim 1, wherein opposite longitudinally extending edges of the rail are captured by the top cap.

7. The apparatus of claim 6, wherein the longitudinally extending edges of the rail are slidably received in a slot of the top cap.

8. The apparatus of claim 7, wherein the top cap comprises a longitudinally extending C-shape channel that bounds and defines the slot.

9. The apparatus of claim 7, comprising at least two of the rails received in end to end relation in the slot.

10. The apparatus of claim 6, wherein the top cap encapsulates the opposite edges of the rail.

11. The apparatus of claim 1, comprising at least one of the locking mechanisms received in a selected one of the attachment slots, respectively, and releasably engaged with the surfaces bounding the slot.

12. The apparatus of claim 1, wherein the elongate rail is incorporated onto the upper portion of the side wall by at least one element secured in a stake hole in the side wall.

13. The apparatus of claim 12, wherein the element secured in the stake hole comprises an expanded clamp.

14. The apparatus of claim 12, wherein the element secured in the stake hole comprises a toggle clamp.

15. The apparatus of claim 12, wherein the element secured in the stake hole comprises a draw bolt clamp.

16. A vehicle load support and attachment apparatus, comprising:
a rail incorporated onto an upper portion of a side wall bounding one side of a bed of the vehicle, the rail having at least one attachment slot configured to lockingly receive a resiliently locking bar of a locking mechanism for securing an item to the rail, wherein the rail is incorporated onto the side wall by a clamp secured in a stake hole in the side wall.

17. The apparatus of claim 16, wherein the clamp secured in the stake hole comprises an expanded clamp.

18. The apparatus of claim 16, wherein the clamp secured in the stake hole comprises a toggle clamp.

19. The apparatus of claim 16, wherein the clamp secured in the stake hole comprises a draw bolt clamp.
